(19) United States
(12) Patent Application Publication
(10) Pub. No.: US 2008/0149407 A1
(43) Pub. Date: Jun. 26, 2008

(54) Control apparatus and control method for vehicular drive system

(75) Inventors: Hiroyuki Shibata, Susono-shi (JP); Tooru Matsubara, Toyota-shi (JP); Atsushi Tabata, Okazaki-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/004,040

(22) Filed: Dec. 20, 2007

(30) Foreign Application Priority Data
Dec. 25, 2006 (JP) 2006-347770

(51) Int. Cl. B60W 10/04; B60K 1/04; B60W 10/10; F16H 37/08; F16H 48/00; H02J 7/00; G06F 19/00; B60K 6/36; B60K 6/543

(52) U.S. Cl. 180/65.2; 477/37; 477/35; 475/151; 475/150; 475/5; 477/3; 318/139; 320/134; 701/54

(57) ABSTRACT

In a control apparatus of a vehicular drive system, a charging/discharging-restricted shift control apparatus makes a determination to perform a shift in a shifting portion such that less power is charged to a power storage device or discharged from a power storage device when charging or discharging of the power storage device is restricted than when charging or discharging of the power storage device is not restricted.

### INCORPORATION BY REFERENCE

The disclosure of Japanese Patent Application No. 2006-347770 filed on Dec. 25, 2006, including the specification, drawings and abstract is incorporated herein by reference in its entirety.

### BACKGROUND OF THE INVENTION

1. Field of the Invention

The invention relates to a control apparatus and a control method for a vehicular drive system provided with i) an electric differential portion having a differential mechanism capable of differential operation, and ii) a shifting portion provided in a power transmitting path from the electric differential portion to driving wheels. More particularly, the invention relates to a control apparatus and a control method of a vehicular drive system when charging or discharging of a power storage device is restricted.

2. Description of the Related Art

One well-known control apparatus for a vehicular drive system includes an electric differential portion and a shifting portion. The electric differential portion includes a differential mechanism which has three elements, i.e., a first element that is connected to an engine, a second element that is connected to a first electric motor, and a third element that is connected to a transmitting member. This differential mechanism distributes output from the engine to the first electric motor and the transmitting member. The shifting portion is provided in the power transmitting path from the transmitting member to driving wheels.

Japanese Patent Application Publication No. 2003-127681 (JP-A-2003-127681), for example, describes a control apparatus for a vehicular drive system that is provided with an electric differential portion and a shifting portion that is formed of a stepped automatic transmission. The electric differential portion of this control apparatus also includes a second electric motor which is operatively connected to the transmitting member, and the differential mechanism is made up of a planetary gear set. In this kind of control apparatus for a vehicular drive system, the engine speed can be controlled to a predetermined speed by controlling the rotation speed of the first electric motor, even if the input rotation speed of the shifting portion (i.e., the rotation speed of the transmitting member) changes due to a shift being performed in the shifting portion. For example, from the viewpoint of operating the engine in an efficient operating range, it is possible to control the driving state of the engine (such as the engine speed and engine torque) so that the engine operates on a well-known optimum fuel efficiency curve before and after a shift in the shifting portion.

The control apparatus for a vehicular drive system that is described in JP-A-2003-127681 controls the rotation speed of the first electric motor by using the first electric motor M1 as a generator and generating reaction force according to the output of the engine that is distributed to the first electric motor. The electric energy generated by the first electric motor M1 is supplied to a power storage device and a second electric motor via an inverter, for example.

However, the amount of power that can be charged to or discharged from the power storage device changes depending on the temperature and state-of-charge (SOC) of the power storage device itself. Therefore, charging to the power storage device or discharging from the power storage device (in this specification, this may also be referred to as “charging/discharging of the power storage device”) may be restricted, i.e., restricted, based on the power that can be charged to or discharged from the power storage device so that the durability of the power storage device does not decline. Alternatively or in addition, the output (power) able to be generated by the second electric motor changes depending on the temperature of the second electric motor itself. As a result, the output of the second electric motor may be restricted to within that possible output range.

Therefore, when there are restrictions placed on charging/discharging of the power storage device and the output of the second electric motor, power is not able to be balanced. As a result, the rotation speed of the first electric motor may not be able to be controlled appropriately when a shift is performed in the shifting portion, which may increase shift shock.

Also, with the control apparatus for a vehicular drive system that is described in JP-A-2003-127681, the vehicle can be run using only the second electric motor as the driving power source (i.e., so-called motor-running is possible). During motor-running, in order to suppress drag (static friction resistance) from the engine, which is stopped, the first electric motor may be made to rotate idly and the engine speed kept at zero or substantially zero by that drag and the differential operation of the electric differential portion, for example.

However, when a shift is performed in the shifting portion during motor-running, the input rotation speed of the shifting portion changes. If the inertia effect from that change is greater than the drag from the engine itself, the engine speed may change instead of being kept at zero or substantially zero because the first electric motor is rotating idly. In particular, as shown in FIG. 18, when an upshift is performed in the shifting portion during motor-running, the engine speed may enter the negative rotation speed range.

FIG. 18 is a well-known alignment graph that shows the rotation speeds of the rotating elements that make up the electric differential portion, as well as an example of a change in the rotation speeds of the rotating elements on that alignment graph when an 1st→2nd upshift is performed in the shifting portion during motor-running. In FIG. 18, [ENG] represents the rotation speed of the first rotating element (i.e., first element) that is connected to the engine, [M1] represents the rotation speed of the second rotating element (i.e., second element) that is connected to the first electric motor, and [M2] represents the rotation speed of the third rotating element (i.e., third element) that is connected to the transmitting member and the second electric motor. Also, the straight lines of the electric differential portion illustrate the relationship among the rotation speeds of the rotating elements. The solid line a represents the relationship before the upshift, and the solid line b represents the relationship after the upshift.

Then, as shown in FIG. 18, when the rotation speed [M2] of the third element decreases following the 1st→2nd upshift in the shifting portion, the engine speed is able to be kept at zero or substantially zero by the differential operation of the electric differential portion and the drag from the engine itself because the first electric motor is rotating idly. However, if the inertia effect during that shift is greater than the drag from the engine itself, the engine speed may enter the negative rotation speed range.

With this kind of phenomenon, the durability of the engine may decline and the drivability may deteriorate due to the effect of the inertia effect on the output rotating member of the electric differential portion (i.e., the input rotating member of the shifting portion). However, these kinds of issues were not investigated in the past and were thus unknown. To prevent such problems, it is possible to keep the engine speed at a predetermined speed equal to or greater than zero such that the engine speed will not enter the negative rotation speed range by, for example, temporarily driving the first electric motor and controlling its rotation speed during an upshift in the shifting portion during motor-running. At this time, as described above, if charging or discharging of the power storage device is restricted, it may not be possible to appropriately control the rotation speed of the first electric motor when a shift in the shifting portion is performed during motor-running.

### SUMMARY OF THE INVENTION

This invention thus provides a control apparatus and a control method for a vehicular drive system, which can appropriately control the rotation speed of the first electric motor during a shift in a shifting portion when a restriction is placed on charging or discharging of a power storage device that supplies power when driving the first electric motor or charges when generating power with a first electric motor.

A first aspect of the invention relates to a control apparatus of a vehicular drive system, which includes i) an electric differential portion that has a differential mechanism which has a first element that is connected to an engine, a second element that is connected to a first electric motor, and a third element that is connected to a transmitting member, the differential mechanism distributing output from the engine to the first electric motor and the transmitting member, ii) a shifting portion that is provided in a power transmitting path between the transmitting member and a driving wheel, iii) a power storage device that supplies power which is used to drive the first electric motor or charges power which is generated by the first electric motor, and iv) a charging/discharging-restricted shift control apparatus that makes a determination to perform a shift in the shifting portion such that less power is charged to the power storage device or discharged from the power storage device when charging or discharging of the power storage device is restricted than when charging or discharging of the power storage device is not restricted, when a shift is performed in the shifting portion by controlling the rotation speed of the first electric motor.

According to this structure, when there is a restriction placed on charging or discharging of the power storage device which supplies power when driving the first electric motor and charges when generating power with the first electric motor, the charging/discharging-restricted shift control apparatus makes a determination to perform a shift in the shifting portion so that less power is charged to or discharged from the power storage device than when charging or discharging of the power storage device is not restricted. Accordingly, the rotation speed of the first electric motor can be appropriately controlled when a shift is performed in the shifting portion when charging or discharging of the power storage device is restricted. As a result, the durability of the power storage device can be improved. In addition, shift shock resulting from not being able to appropriately control the rotation speed of the first electric motor due to a restriction being placed on the charging or discharging of the power storage device when a shift is performed in the shifting portion can be suppressed.

The charging/discharging-restricted shift control apparatus may make the shifting portion shift at a lower vehicle speed when charging or discharging of the power storage device is restricted than when charging or discharging of the power storage device is not restricted. Accordingly, the amount of change in the input rotating member of the shifting portion (i.e., the amount of change in the rotation speed of the transmitting member) is reduced during a shift in the shifting portion so the power necessary to drive the first electric motor or the power generated by the first electric motor can be reduced when controlling the engine speed to a predetermined speed. As a result, the rotation speed of the first electric motor can be appropriately controlled even if charging or discharging of the power storage device is restricted.

The charging/discharging-restricted shift control apparatus may make the shifting portion shift at a progressively lower vehicle speed the more charging or discharging of the power storage device is restricted. Accordingly, the rotation speed of the first electric motor can be controlled even more appropriately according to the restriction placed on charging or discharging of the power storage device.

The shifting portion may be an automatic transmission in which a shift is executed according to a preset first shift map, and the charging/discharging-restricted shift control apparatus may execute a shift according to a second shift map which is set to shift at a lower vehicle speed than the vehicle speed set by the first shift map. Accordingly, the amount of change in the input rotating member of the shifting portion (i.e., the amount of change in the rotation speed of the transmitting member) is reduced during a shift in the shifting portion so the power necessary to drive the first electric motor or the power generated by the first electric motor can be reduced when controlling the engine speed to a predetermined speed. As a result, the rotation speed of the first electric motor can be appropriately controlled even if charging or discharging of the power storage device is restricted.

The charging/discharging-restricted shift control apparatus may change a shift point farther to the lower vehicle speed side the more charging or discharging of the power storage device is restricted. Accordingly, the rotation speed of the first electric motor can be controlled even more appropriately according to the restriction placed on charging or discharging of the power storage device.

When only charging to the power storage device is restricted, the charging/discharging-restricted shift control apparatus may make a determination to perform a shift in the shifting portion such that the power that is charged to the power storage device become lower, or may make the determination when the power storage device discharges. Accordingly, the rotation speed of the first electric motor can be even more appropriately controlled to match the restriction on charging or discharging of the power storage device. For example, the opportunity for a determination to perform a shift in the shifting portion that is normally performed when charging or discharging of the power storage device is not restricted increases compared to when a determination to perform a shift in the shifting portion is made uniformly so that less power is charged or discharged to or from the power storage device when only charging of the power storage device is restricted.

When only discharging from the power storage device is restricted, the charging/discharging-restricted shift control apparatus may make a determination to perform a shift in the shifting portion such that the power that is discharged from the power storage device become lower, or may make the determination when the power storage device charges. Accordingly, the rotation speed of the first electric motor can be even more appropriately controlled to match the restriction on charging or discharging of the power storage device. For example, the opportunity for a determination to perform a shift in the shifting portion that is normally performed when charging or discharging of the power storage device is not restricted increases compared to when a determination to perform a shift in the shifting portion is made uniformly so that less power is charged or discharged to or from the power storage device when only discharging of the power storage device is restricted.

In the first aspect, a second electric motor that is connected to the transmitting member may also be provided. In addition, the charging/discharging-restricted shift control apparatus may make a determination to perform a shift in the shifting portion such that less power is charged to the power storage device or discharged from the power storage device when charging or discharging of the power storage device is restricted than when charging or discharging of the power storage device is not restricted, during motor-running in which only the second motor is used as a driving power source. Accordingly, the rotation speed of the first electric motor can be appropriately controlled when a shift is performed in the shifting portion during motor-running. In particular, the durability of the engine can be improved by inhibiting the engine speed from entering the negative engine speed region during an upshift of the shifting portion.

The charging/discharging-restricted shift control apparatus may make the determination to perform a shift in the shifting portion such that less power is charged to the power storage device or discharged from the power storage device taking into account the power which is used to drive the second electric motor. Accordingly, the rotation speed of the first electric motor can be even more appropriately controlled when a shift is performed in the shifting portion during motor-running. For example, even if neither charging nor discharging is desirable taking the durability of the power storage device into account, a shift can be made to bring the balance of power to equal or close to zero and the rotation speed of the first electric motor can be made even more appropriate.

Charging or discharging of the power storage device may be restricted based on a temperature of the power storage device. Accordingly, charging or discharging of the power storage device can be appropriately restricted so a decline in durability of the power storage device can be suppressed.

Charging or discharging of the power storage device may also be restricted based on a state-of-charge of the power storage device. Accordingly, charging or discharging of the power storage device can be appropriately restricted so a decline in durability of the power storage device can be suppressed.

The electric differential portion may operate as a continuously variable transmission by the operating state of the first electric motor being controlled. Accordingly, the electric differential portion and the shifting portion together make up a continuously variable transmission such that driving torque can be changed smoothly. Incidentally, in addition to operating as an electric continuously variable transmission by continuously changing the speed ratio, the electric differential portion can also operate as a stepped transmission by changing the speed ratio in a stepped manner.

The differential mechanism may be a planetary gear set having a first element that is connected to the engine, a second element that is connected to the first electric motor, and a third element that is connected to the transmitting member. The first element may be a carrier of the planetary gear set, the second element may be a sun gear of the planetary gear set, and the third element may be a ring gear of the planetary gear set. Accordingly, the dimensions in the axial direction of the differential mechanism can be reduced. Also, the differential mechanism can be easily made using one planetary gear set.

The planetary gear set may be a single pinion type planetary gear set. Accordingly, the dimensions in the axial direction of the differential mechanism can be reduced. Also, the differential mechanism can be easily made using one single pinion type planetary gear set.

A total speed ratio of the vehicular drive system may be obtained based on a speed ratio of the shifting portion and a speed ratio (i.e., gear ratio) of the electric differential portion. Accordingly, driving force across a wide range can be obtained using the speed ratios of the shifting portion.

The shifting portion may be a stepped automatic transmission. Accordingly, for example, the electric differential portion and the shifting portion together can make up a continuously variable transmission such that driving torque can be changed smoothly. In addition, when the speed ratio of the electric differential portion is controlled to be constant, the stepped transmission can be placed in the same state by the electric differential portion and the stepped automatic transmission. As a result, driving torque can also be obtained quickly by changing the total speed ratio of the vehicular drive system in a stepped manner.

A second aspect of the invention relates to a control method for a vehicular drive system that includes i) an electric differential portion that has a differential mechanism which has a first element that is connected to an engine, a second element that is connected to a first electric motor, and a third element that is connected to a transmitting member, the differential mechanism distributing output from the engine to the first electric motor and the transmitting member, ii) a shifting portion that is provided in a power transmitting path between the transmitting member and a driving wheel, and iii) a power storage device that supplies power which is used to drive the first electric motor or charges power which is generated by the first electric motor. This control method includes making a determination to perform a shift in the shifting portion such that less power is charged to the power storage device or discharged from the power storage device when charging or discharging of the power storage device is restricted than when charging or discharging of the power storage device is not restricted, when a shift is performed in the shifting portion by controlling the rotation speed of the first electric motor.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a skeleton view of the structure of a drive system of a hybrid vehicle according to one example embodiment of the invention;

FIG. 2 is a clutch and brake application chart showing various application and release combinations of hydraulic friction apply devices used for shift operations in the drive system shown in FIG. 1;

FIG. 3 is an alignment graph illustrating the relative rotation speeds at each speed of the drive system shown in FIG. 1;

FIG. 4 is a view showing input and output signals of an electronic control apparatus provided in the drive system shown in FIG. 1;

FIG. 5 is a circuit diagram related to a linear solenoid valve that controls the operation of various hydraulic actuators of clutches and brakes in a hydraulic control circuit;

FIG. 6 is an example of a shift operation executing apparatus provided with a shift lever that is operated to select any of a plurality of various shift positions;

FIG. 7 is a functional block line diagram showing the main portions of the control functions according to the electronic control apparatus shown in FIG. 4;

FIG. 8 is a view showing an example of a shift map used in shift control of the drive system and an example of a driving power source map used in driving power source switching control that switches between engine-running and motor-running, as well as the relationship between the two maps;

FIG. 9 is an example of a fuel efficiency map in which the broken line is the optimum fuel efficiency curve for the engine;

FIG. 10 is a chart showing an example of a target engine speed and a target M1 change rate set for each speed before a shift in an automatic shifting portion;

FIG. 11 is an example of an input/output restriction map that was set by obtaining the relationship between the power storing device temperature and the input/output restrictions through testing beforehand;

FIG. 12 is a graph showing an example of an input/output restriction correction coefficient map that was set by obtaining the relationship between the state-of-charge and the correction coefficients for the input/output restrictions through testing beforehand;

FIG. 13 is a graph showing an example of an electric motor output map that was set by obtaining the relationship between the electric motor temperature and the electric motor output (driving/power generation) through testing beforehand;

FIG. 14A is a graph showing an enlarged view of the motor-running region in the driving power source map and the shift map shown in FIG. 8, and an example of 1st [symbol] 2nd shift lines that are normally set when charging/discharging of the power storage device is not restricted and/or when the output of the electric motor is not restricted, and FIG. 14B is a graph showing an enlarged view of the motor-running region in the driving power source map and the shift map shown in FIG. 8, and an example of 1st [symbol] 2nd shift lines that are normally set when charging/discharging of the power storage device is restricted and/or when the output of the electric motor is restricted;

FIG. 15 is a flowchart illustrating a routine that includes a control operation of the electronic control apparatus shown in FIG. 4, i.e., a control operation for improving drivability when performing a shift in an automatic shifting portion during motor-running, particularly a control operation for improving durability of the engine in addition to improving drivability when the shift in the automatic shifting portion is an upshift;

FIG. 16 is a flowchart illustrating a routine that includes a control operation of the electronic control apparatus shown in FIG. 4, i.e., a control operation for appropriately controlling the rotation speed of a first electric motor during the shift in the automatic shifting portion in the flowchart in FIG. 15 when charging/discharging of the power storage device is restricted;

FIG. 17 is a time chart showing the control operation in the flowcharts in FIGS. 15 and 16, and an example of a case in which a 1st→2nd upshift is performed in the automatic shifting portion during motor-running; and

FIG. 18 is a well-known alignment graph showing the rotation speeds of rotating elements that make up a differential portion, as well as an example of a change in the rotation speeds of those rotating elements on that alignment graph when a 1st→2nd upshift is performed in the automatic shifting portion during motor-running.

### DETAILED DESCRIPTION OF THE EMBODIMENTS

In the following description and the accompanying drawings, the present invention will be described in more detail in terms of example embodiments.

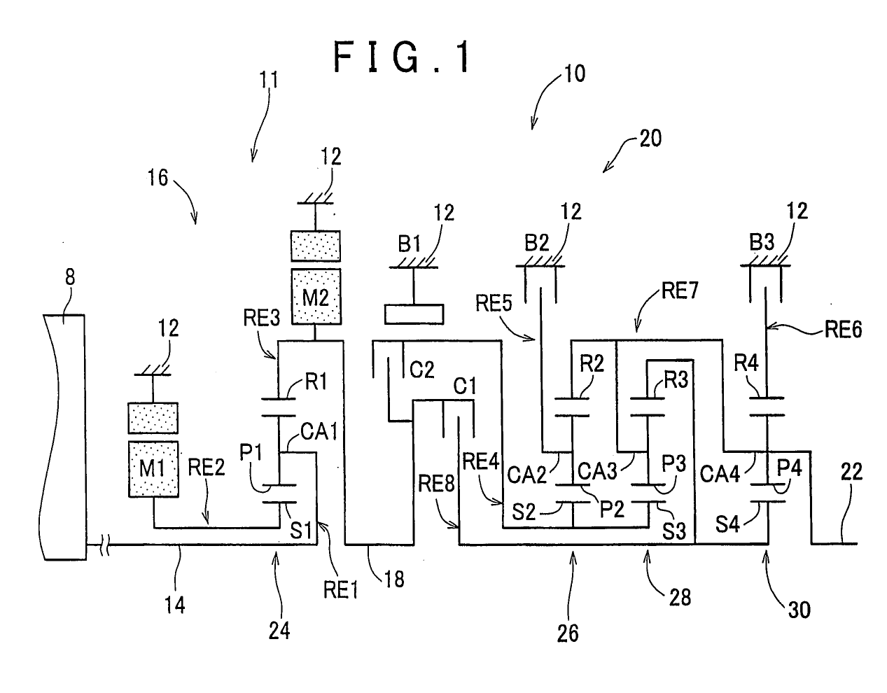

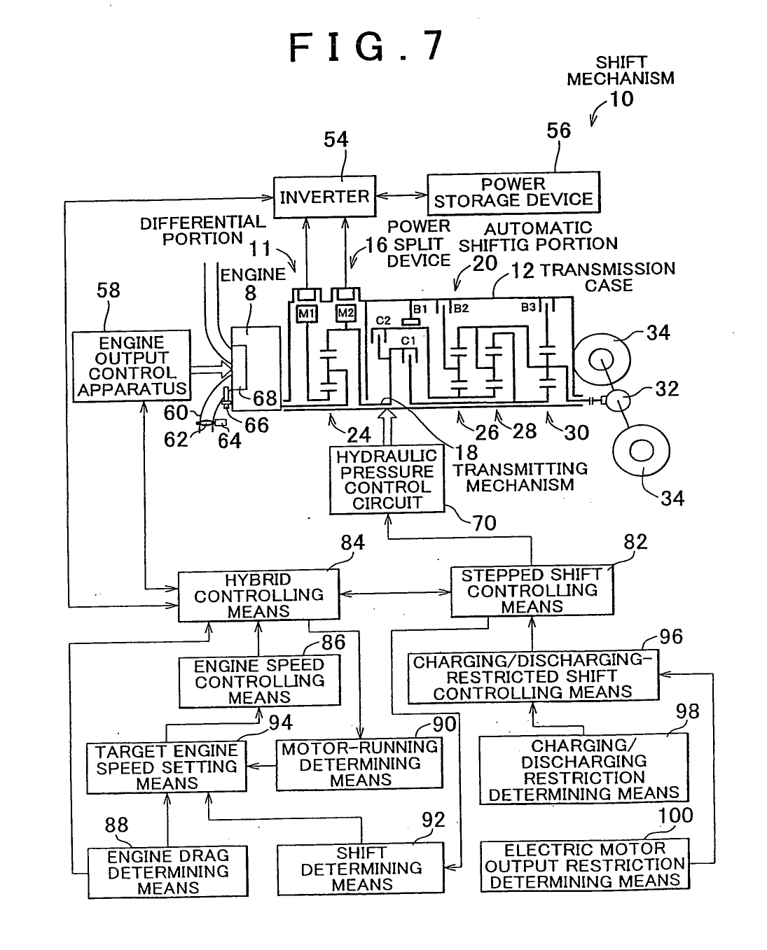

FIG. 1 is a skeleton view of shift mechanism 10 that constitutes part of a drive system of a hybrid vehicle to which the invention can be applied. In FIG. 1, the shift mechanism 10 includes, in series, an input shaft 14, an electric differential portion (hereinafter simply referred to as “differential portion”) 11, an automatic shifting portion 20, and an output shaft 22. The input shaft 14 is an input rotating member that is arranged inside a transmission case 12, which is a non-rotating member that is attached to the vehicle body (hereinafter this transmission case 12 will simply be referred to as “case 12”), on a common axis. The differential portion 11 is a continuously variable shifting portion that is either directly connected to the input shaft 14 or indirectly connected to the input shaft 14 via a pulsation absorbing damper (i.e., a pulsation damping device), not shown, and the like. The automatic shifting portion 20 is a power transmitting portion that is connected in series via a transmitting member (i.e., a transmitting shaft) 18 in the power transmitting path between the differential portion 11 and driving wheels 34 (see FIG. 7). The output shaft 22 is an output rotating member that is connected to the automatic shifting portion 20. The shift mechanism 10 is preferably used in an FR (front-engine, rear-drive) type vehicle in which it is longitudinal mounted in the vehicle, for example. The shift mechanism 10 is provided between a pair of driving wheels 34 and an engine 8 which is an internal combustion engine such as a gasoline engine or a diesel engine, for example, that serves as a driving power source for running which is either directly connected to the input shaft 14 or indirectly connected to the input shaft 14 via a pulsation absorbing damper, not shown. This shift mechanism 10 transmits power from the engine 8 to the pair of driving wheels 34 via a differential gear unit (final reduction device) 32 (see FIG. 7) that makes up part of the power transmitting path and a pair of axles and the like, in that order.

In this way, in the shift mechanism 10 of this example embodiment, the engine 8 and the differential portion 11 are directly connected. The phrase “directly connected” here means that they are connected without a fluid power transmitting device such as a fluid-coupling or a torque converter provided between them, although they may be connected via the pulsation absorbing damper or the like, for example, and still be considered as being directly connected. Incidentally, the shift mechanism 10 has a symmetrical structure with respect to its axis so the lower side is omitted in the skeleton view in FIG. 1. This is also true for each of the following example embodiments.

The differential portion 11 includes a first electric motor M1, a power split device 16, and a second electric motor M2. The power split device 16 is a mechanical device which mechanically distributes power that was input to the input shaft 14 from the engine 8. This power split device 16 serves as a differential mechanism which distributes the power from the engine 8 to the first electric motor M1 and the transmitting member 18. The second electric motor M2 is operatively linked to the transmitting member 18 so that it rotates together with the transmitting member 18. The first electric motor M1 and the second electric motor M2 in this example embodiment are each a so-called motor-generator that can also function as a generator. The first electric motor M1 at least functions as a generator (i.e., is capable of generating power) for generating reaction force, and the second generator M2 at least functions as a motor (i.e., an electric motor) that outputs driving force as a driving power source for running.

The power split device 16 has as its main component a single pinion type first planetary gear set 24 having a predetermined gear ratio ρ1 of approximately 0.418, for example. This first planetary gear set 24 has as rotating elements (i.e., elements) a first sun gear S1, first pinion gears P1, a first carrier CA1 which rotatably and revolvably supports the first pinion gears P1, and a first ring gear R1 that is in mesh with the first sun gear S1 via the first pinion gears P1. When the number of teeth on the first sun gear S1 is ZS1 and the number of teeth on the first ring gear R1 is ZR1, the gear ratio ρ1 is ZS1/ZR1.

In this power split device 16, the first carrier CA1 is connected to the input shaft 14, i.e., the engine 8, the first sun gear S1 is connected to the first electric motor M1, and the first ring gear R1 is connected to the transmitting member 18. In the power split device 16 that is structured in this way, the first sun gear S1, the first carrier CA1, and the first ring gear R1 are each able to rotate relative one another. As a result, the power split device 16 is capable of differential operation. Therefore, the output from the engine 8 can be distributed to the first electric motor M1 and the transmitting member 18, while some of the output from the engine 8 that was distributed is used to run the first electric motor M1 to generate electric energy to be stored, as well as used run the second electric motor M2 to provide driving force. In this way, the differential portion 11 (i.e., the power split device 16) functions as an electric differential apparatus. For example, the differential portion 11 may be placed in a so-called continuously variable state (i.e., electric CVT state) and the rotation speed of the transmitting member 18 can be continuously (i.e., smoothly) changed regardless of the predetermined speed of the engine 8. That is, the differential portion 11 functions as an electric continuously variable transmission in which its speed ratio γ0 (the rotation speed N_{IN} of the input shaft 14 divided by the rotation speed N₁₈ of the transmitting member 18) can be continuously (i.e., smoothly) changed from a minimum value γ0min to a maximum value γ0max.

The automatic shifting portion 20 is a planetary gear type multi-speed transmission that functions as a stepped automatic transmission and includes a single pinion type second planetary gear set 26, a single pinion type third planetary gear set 28, and a single pinion type fourth planetary gear set 30. The second planetary gear set 26 includes a second sun gear S2, second pinion gears P2, a second carrier CA2 which rotatably and revolvably supports the second pinion gears P2, and a second ring gear R2 that is in mesh with the second sun gear S2 via the second pinion gears P2, and has a gear ratio ρ2 of approximately 0.562, for example. The third planetary gear set 28 includes a third sun gear S3, third pinion gears P3, a third carrier CA3 which rotatably and revolvably supports the third pinion gears P3, and a third ring gear R3 that is in mesh with the third sun gear S3 via the third pinion gears P3, and has a gear ratio ρ3 of approximately 0.425, for example. The fourth planetary gear set 30 includes a fourth sun gear S4, fourth pinion gears P4, a fourth carrier CA4 which rotatably and revolvably supports the fourth pinion gears P4, and a fourth ring gear R4 that is in mesh with the fourth sun gear S4 via the fourth pinion gears P4, and has a gear ratio ρ4 of approximately 0.421, for example. When the number of teeth of the second sun gear S2 is ZS2, the number of the teeth on the second ring gear R2 is ZR2, the number of teeth on the third sun gear S3 is ZS3, the number of teeth on the third ring gear R3 is ZR3, the number of teeth on the fourth sun gear S4 is ZS4, and the number of teeth on the fourth ring gear R4 is ZR4, the gear ratio ρ2 is ZS2/ZR2, the gear ratio ρ3 is ZS3/ZR3, and the gear ratio ρ4 is ZS4/ZR4.

In the automatic shifting portion 20, the second sun gear S2 and the third sun gear S3 are integrally connected together as well as selectively connected to the transmitting member 18 via the second clutch C2 and selectively connected to the case 12 via the first brake B1. The second carrier CA2 is selectively connected to the case 12 via the second brake B2. The fourth ring gear R4 is selectively connected to the case 12 via the third brake B3. The second ring gear R2, the third carrier CA3, and the fourth carrier CA4 are integrally connected together as well as to the output shaft 22. The third ring gear R3 and the fourth sun gear S4 are integrally connected together as well as selectively connected to the transmitting member 18 via the first clutch C1.

In this way, the differential portion 11 (i.e., the transmitting member 18) is selectively connected to the inside of the automatic shifting portion 20 via the first clutch C1 or the second clutch C2 which are used to establish various speeds in the automatic shifting portion 20. In other words, the first clutch C1 and the second clutch C2 function as apply devices that selectively change the power transmitting path between the transmitting member 18 and the automatic shifting portion 20, i.e., from the differential portion 11 (i.e., the transmitting member 18) to the driving wheels 34, between a power transmittable state in which power is able to be transmitted along that power transmitting path and a power transmission-interrupted state in which power is not able to be transmitted (i.e., the flow of power is interrupted) along that power transmitting path. That is, applying at least one of the first clutch C1 and the second clutch C2 places the power transmitting path in the power transmittable state. Conversely, releasing the first clutch C1 and the second clutch C2 places the power transmitting path in the power transmission-interrupted state.

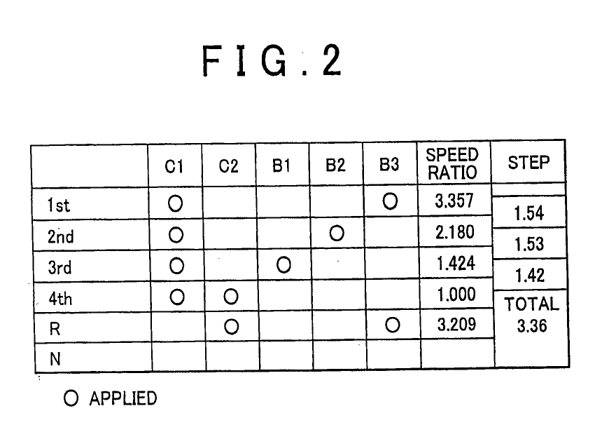

Also, this automatic shifting portion 20 selectively establishes a given speed by performing a clutch-to-clutch shift by releasing one apply device (i.e., an apply device to be released, hereinafter also referred to as a “release-side apply device”) and applying another (i.e., an apply device to be applied, hereinafter also referred to as an “apply-side apply device). Accordingly, a speed ratio γ (=the rotation speed N₁₈ of the transmitting member 18 divided by the rotation speed N_{OUT} of the output shaft 22) that changes in substantially equal ratio is able to be obtained for each speed. For example, as shown in the clutch and brake application chart in FIG. 2, first speed which has the largest speed ratio γ1, e.g., approximately 3.357, can be established by applying the first clutch C1 and the third brake B3. Second speed which has a speed ratio γ2 smaller than that of first speed, e.g., approximately 2.180, can be established by applying the first clutch C1 and the second brake B2. Third speed which has a speed ratio γ3 smaller than that of second speed, e.g., approximately 1.424, can be established by applying the first clutch C1 and the first brake B1. Fourth speed which has a speed ratio γ4 smaller than that of third speed, e.g., approximately 1.000, can, be established by applying the first clutch C1 and the second clutch C2. Reverse (i.e., a reverse speed) which has a speed ratio γR between that of first speed and that of second speed, e.g., approximately 3.209, can be established by applying the second clutch C2 and the third brake B3. Also, the automatic shifting portion 20 can be placed in neutral “N” by releasing all of the clutches and brakes, i.e., the first clutch C1, the second clutch C2, the first brake B1, the second brake B2, and the third brake B3.

The first clutch C1 the second clutch C2, the first brake B1, the second brake B2, and the third brake B3 (hereinafter these will simply be referred to as “clutches C” and “brakes B” when not particularly specified) are hydraulic friction apply devices which function as apply elements that are often used in conventional vehicular automatic transmissions. These clutches C may be wet type multiple disc clutches in which a plurality of stacked friction plates are pressed together by a hydraulic actuator, and the brakes B may be a band brakes in which the one end of one or two bands that are wound around the outer peripheral surface of a rotating drum is pulled tight by a hydraulic actuator. The hydraulic friction apply devices selectively connect members on either side of them.

In the shift mechanism 10 having a structure such as that described above, a continuously variable transmission is on the whole made up by the automatic shifting portion 20 and the differential portion 11 that functions as a continuously variable transmission. Also, by controlling the speed ratio of the differential portion 11 so that it is constant, the shift mechanism 10 can be placed in the same state as a stepped transmission by the differential portion 11 and the automatic shifting portion 20.

More specifically, by using the differential portion 11 as a continuously variable transmission and using the automatic shifting portion 20, which is in series with the differential portion 11, as a stepped transmission, the rotation speed input to the automatic shifting portion 20 (i.e., the input rotation speed of the automatic shifting portion 20), i.e., the rotation speed of the transmitting member 18 (hereinafter referred to as the “transmitting member rotation speed N₁₈”) is continuously (i.e., smoothly) changed with respect to at least one speed M of the automatic shifting portion 20 such that a continuous speed ratio range can be obtained for that speed M. Therefore, the total speed ratio γT (=rotation speed N_{IN} of the input shaft 14/rotation speed N_{OUT} of the output shaft 22) can be obtained in a continuous, non-stepped manner, such that a continuously variable transmission is formed in the shift mechanism 10. The total speed ratio γT is the total speed ratio γT for the overall shift mechanism 10 that is established based on the speed ratio γ0 of the differential portion 11 and the speed ratio γof the automatic shifting portion 20.

For example, a continuous speed ratio range can be obtained for each speed by continuously (i.e., smoothly) changing the transmitting member rotation speed N₁₈ for each speed (i.e., 1st speed to 4th speed and reverse) of the automatic shifting portion 20 shown in the clutch and brake application chart in FIG. 2. As a result, there are continuously variable speed ratios between the speeds such that the total speed ratio γT for the overall shift mechanism 10 can be continuous (i.e., non-stepped).

Also, the total speed ratio γT of the shift mechanism 10 that changes in substantially equal ratio for each speed can be obtained by selectively establishing any one of the four forward speeds (1st speed to 4th speed) or reverse by controlling the speed ratio of the differential portion 11 to be constant and selectively applying the clutches C and brakes B. Therefore, the shift mechanism 10 can be placed in the same state as a stepped transmission.

For example, when the speed ratio γ0 of the differential portion 11 is controlled so that it is fixed at 1, the total gear ratio γT of the shift mechanism 10 corresponding to each speed (i.e., 1st speed to 4th speed and reverse) in the automatic shifting portion 20 can be obtained for each speed as shown in the clutch and brake application chart in FIG. 2. Also, when the speed ratio γ0 of the differential portion 11 is controlled so that it is fixed at a value that is less than 1, such as approximately 0.7, in fourth speed of the automatic shifting portion 20, the total speed ratio γT of a value less than that of fourth speed, such as approximately 0.7, can be obtained.

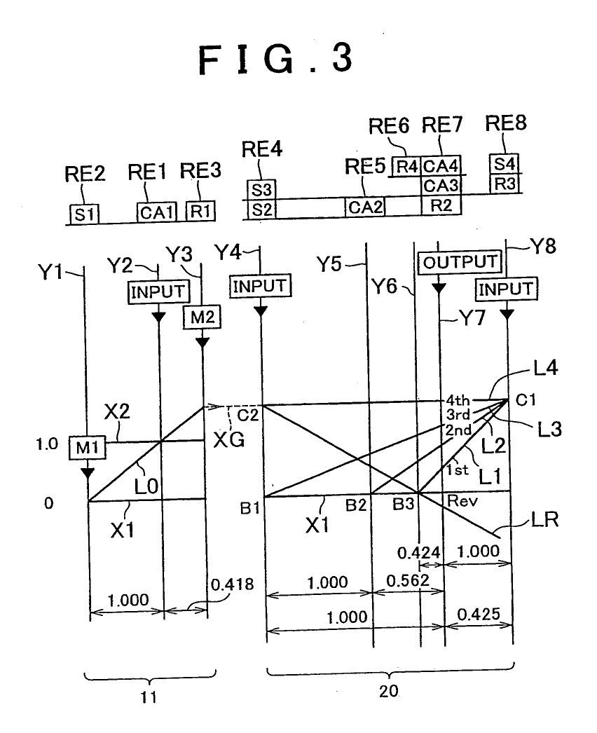

FIG. 3 is an alignment graph which shows the relationship, on straight lines, among the rotation speeds of the various rotating elements that are in different connective states in each speed in the shift mechanism 10 that is made up of the differential portion 11 and the automatic shifting portion 20. This alignment graph in FIG. 3 is a two-dimension coordinate system having a horizontal axis that represents the relationship among the gear ratios ρ of the planetary gear sets, and a vertical axis that represents the relative rotation speeds. The horizontal line X1 represents a rotation speed of zero, the horizontal line X2 represents a rotation speed of 1.0, i.e., the rotation speed N_{E} of the engine 8 that is connected to the input shaft 14, and the horizontal line XG represents the rotation speed of the transmitting member 18.

Also, the three vertical lines Y1, Y2, and Y3 corresponding to the three elements of the power split device 16 that forms the differential portion 11 represent, in order from left to right, the relative rotation speeds of the first sun gear S1 corresponding to a second rotating element (second element) RE2, the first carrier CA1 corresponding to a first rotating element (first element) RE1, and the first ring gear R1 corresponding to a third rotating element (third element) RE3. The intervals between the vertical lines Y1, Y2, and Y3 are determined by the gear ratio ρ1 of the first planetary gear set 24. Further, the five vertical lines Y4, Y5, Y6, Y7, and Y8 of the automatic shifting portion 20 represent, in order from left to right, the second sun gear S2 and the third sun gear S3 which are connected together and correspond to a fourth rotating element (fourth element) RE4, the second carrier CA2 corresponding to a fifth rotating element (fifth element) RE5, the fourth ring gear R4 corresponding to a sixth rotating element (sixth element) RE6, the second ring gear R2, the third carrier CA3, and the fourth carrier CA4 which are connected together and correspond to a seventh rotating element (seventh element) RE7, and the third ring gear R3 and the fourth sun gear S4 which are connected together and correspond to an eighth rotating member (eighth element) RE8. The intervals between them are determined according to the gear ratio ρ2 of the second planetary gear set 26, the gear ratio ρ3 of the third planetary gear set 28, and the ρ4 of the fourth planetary gear set 30. In the relationships among the spaces between the vertical axes in the alignment graph, when the space between the sun gear and the carrier is an interval corresponding to 1, the space between the carrier and the ring gear is an interval corresponding to the gear ratio ρof the planetary gear set. That is, in the differential portion 11, the space between the vertical lines Y1 and Y2 is set to an interval corresponding to 1, and the space between vertical lines Y2 and Y3 is set to an interval corresponding to the gear ratio ρ1. Also, in the automatic shifting portion 20, the space between the sun gear and the carrier in each of the second, third, and fourth planetary gear sets 26, 28, and 30 is set to an interval corresponding to 1, and the space between the carrier and the ring gear is set to an interval corresponding to ρ.

When expressed using the alignment graph in FIG. 3, the shift mechanism 10 in this example embodiment is structured such that in the power split device 16 (the differential portion 11), the first rotating element RE1 (i.e., the first carrier CA1) of the first planetary gear set 24 is connected to the input shaft 14, i.e., the engine 8, the second rotating element RE2 is connected to the first electric motor M1, and the third rotating element (i.e., the first ring gear R1) RE3 is connected to the transmitting member 18 and the second electric motor M2 such that the rotation of the input shaft 14 is transmitted (input) to the automatic shifting portion 20 via the transmitting member 18. At this time, the relationship between the rotation speed of the first sun gear S1 and the rotation speed of the first ring gear R1 is shown by the sloped straight line L0 passing through the point of intersection of Y2 and X2.

For example, if the rotation speed of the first carrier CA1 represented by the point of intersection of the straight line L0 and the vertical line Y2 is increased or decreased by controlling the engine speed N_{E} when the differential portion 11 is in a differential state in which the first rotating element RE1, the second rotating element RE2, and the third rotating element RE3 are able to rotate relative one another and the rotation speed of the first ring gear R1 represented by the point of intersection of the straight line L0 and the vertical line Y3 is restricted by the vehicle speed V and substantially constant, the rotation speed of the first sun gear S1 represented by the point of intersection of the straight line L0 and the vertical line Y1, i.e., the rotation speed of the first electric motor M1, will increase or decrease.

Also, if the rotation speed of the first sun gear S1 is made the same as the engine speed N_{E} by controlling the rotation speed of the first electric motor M1 so that the speed ratio γ0 of the differential portion 11 is fixed at 1, the straight line L0 will match the horizontal line X2, and the first ring gear R1, i.e., the transmitting member 18, will rotate at the same speed as the engine speed N_{E}. Alternatively, if the rotation speed of the first sun gear S1 is made zero by controlling the rotation speed of the first motor M1 so that the speed ratio γ0 of the differential portion 11 is fixed at a value less than 1, such as approximately 0.7, the transmitting member rotation speed N₁₈ will be faster than the engine speed N_{E}.

Also, in the automatic shifting portion 20, the fourth rotating element RE4 is selectively connected to the transmitting member 18 via the second clutch C2, as well as selectively connected to the case 12 via the first brake B1. The fifth rotating element RE5 is selectively connected to the case 12 via the second brake B2. The sixth rotating element RE6 is selectively connected to the case 12 via the third brake B3. The seventh rotating element RE7 is connected to the output shaft 22, and the eighth rotating element RE5 is selectively connected to the transmitting member 18 via the first clutch C1.

In the automatic shifting portion 20, when the engine speed N_{E} is input to the eighth rotating element RE5 from the differential portion 11 when the differential portion 11 is in the state represented by the straight line L0, the rotation speed of the output shaft 22 in first speed (1st), which is established by applying the first clutch C1 and the third brake B3, is shown at the point of intersection of i) the sloped straight line L1 that passes through both the point of intersection of the horizontal line XG and the vertical line Y8 that represents the rotation speed of the eighth rotating element RE8, and the point of intersection of the horizontal line X1 and the vertical line Y6 that represents the rotation speed of the sixth rotating element RE6, and ii) the vertical line Y7 that represents the rotation speed of the seventh rotating element RE7 that is connected to the output shaft 22, as shown in FIG. 3. Similarly, the rotation speed of the output shaft 22 in second speed (2nd), which is established by applying the first clutch C1 and the second brake B2, is shown at the point of intersection of the sloped straight line L2 and the vertical line Y7 that represents the rotation speed of the seventh rotating element RE7 that is connected to the output shaft 22. Also, the rotation speed of the output shaft 22 in third speed (3rd), which is established by applying the first clutch C1 and the first brake B1, is shown at the point of intersection of the sloped straight line L3 and the vertical line Y7 that represents the rotation speed of the seventh rotating element RE7 that is connected to the output shaft 22. Similarly, the rotation speed of the output shaft 22 in fourth speed (4th), which is established by applying the first clutch C1 and the second clutch C2, is shown at the point of intersection of the sloped straight line L4 and the vertical line Y7 that represents the rotation speed of the seventh rotating element RE7 that is connected to the output shaft 22.

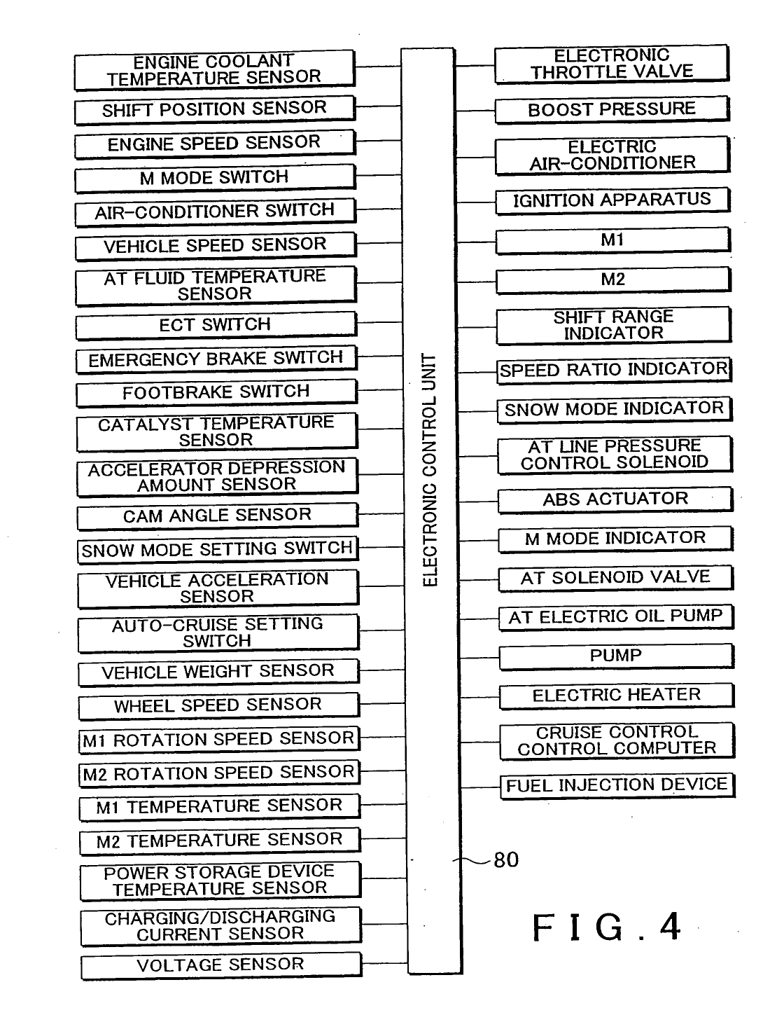

FIG. 4 shows an example of signals input to (i.e., received by) and output from an electronic control apparatus 80 for controlling the shift mechanism 10 in this example embodiment. This electronic control apparatus 80 includes a so-called microcomputer that includes a CPU, ROM, RAM, and input/output interfaces and the like. The electronic control apparatus 80 executes drive control, such as shift control of the automatic shifting portion 20 and hybrid control related to the engine 8 and the first and second electric motors M1 and M2, by processing the signals according to programs stored in advance in the ROM while using the temporary storage function of the RAM.

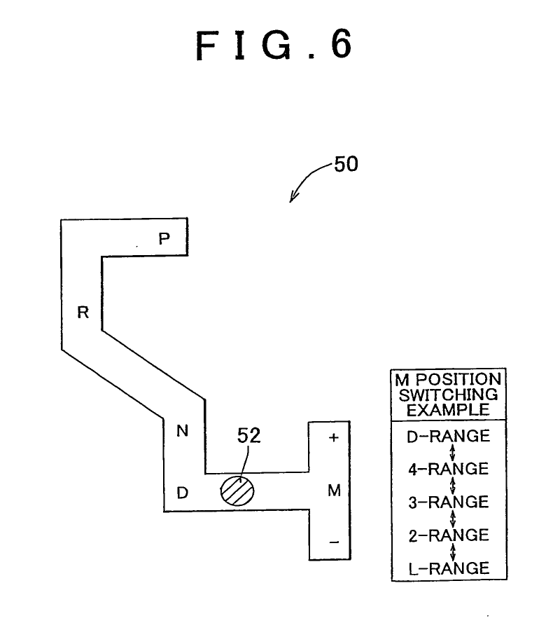

Various signals are input to this electronic control apparatus 80 from various sensors and switches and the like as shown in FIG. 4. Some of these signals include a signal indicative of the engine coolant temperature TEMP_{W}, a signal indicative of the number of operations and the like of a shift position P_{SH} and M position of a shift lever 52 (see FIG. 6), a signal indicative of the engine speed N_{E} which is the speed of the engine 8; a signal indicative of a command to operate in a M mode (manual shift running mode), a signal indicative of operation of an air-conditioner, a signal indicative of the vehicle speed corresponding to the rotation speed of the outputs shaft 22 (i.e., hereinafter simply referred to as the “output shaft rotation speed”) N_{OUT}, a signal indicative of the hydraulic fluid temperature T_{OIL} of the automatic shifting portion 20, a signal indicative of an emergency brake operation, a signal indicative of a footbrake operation, a signal indicative of the catalyst temperature, and a signal indicative of the accelerator depression amount A_{CC} which is the amount that an accelerator pedal is being depressed that corresponds to the amount of output required by the driver. Other signals received by the electronic control apparatus 80 include a signal indicative of the cam angle, a signal indicative of a snow mode setting, a signal indicative of the longitudinal acceleration G of the vehicle, a signal indicative of an auto-cruise control, a signal indicative of the mass (vehicle weight) of the vehicle, a signal indicative of the wheel speed of each wheel, a signal indicative of the rotation speed N_{M1} of the first electric motor M1 (hereinafter simply referred to as “first electric motor rotation speed N_{M1}”), a signal indicative of the rotation speed N_{M2} of the second electric motor M2 (hereinafter simply referred to as “second electric motor rotation speed N_{M2}”), a signal indicative of the temperature of the first electric motor M1 (hereinafter simply referred to as the “first electric motor temperature”) TH_{M1}, a signal indicative of the temperature of the second electric motor M2 (hereinafter simply referred to as the “second electric motor temperature”) TH_{M2}, a signal indicative of the temperature of the power storage device 56 (see FIG. 7) (hereinafter simply referred to as the “power storage device temperature”) TH_{BAT}, a signal indicative of the charging current or discharging current of the power storage device 56 (hereinafter simply referred to as the “charging/discharging current” or “input/output current”) I_{CD}, a signal indicative of the voltage V_{BAT} of the power storage device 56, and a signal indicative of the SOC (state-of charge) of the power storage device 56 that was calculated based on the power storage device temperature TH_{BAT}, the charging/discharging current I_{CD}, and the voltage V_{BAT}.

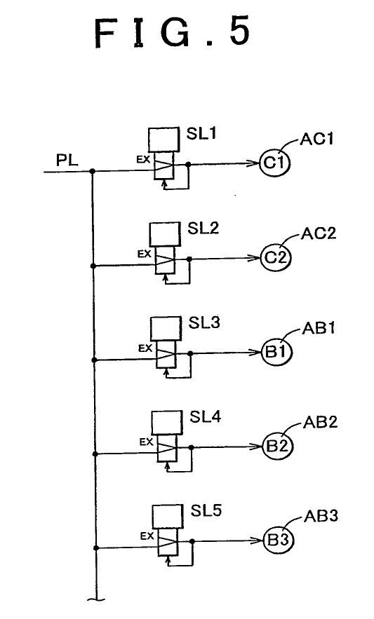

The electronic control apparatus 80 also outputs various signals. Some of these signals include control signals that are output to an engine output control apparatus 58 (see FIG. 7) to control engine output, such as a drive signal to a throttle actuator 64 that operates the throttle valve opening amount θ_{TH} of an electronic throttle valve 62 provided in an intake passage 60 of the engine, a fuel supply quantity signal that controls the amount of fuel supplied to the intake passage 60 or the cylinders of the engine 8 from a fuel injection apparatus 66, an ignition signal that dictates the ignition timing of the engine 8 from an ignition apparatus 68, and a pressure boost adjusting signal for adjusting the boost pressure. Other signals output from the electronic control apparatus 80 include an electric air-conditioner drive signal for operating an electric air-conditioner, command signals indicative of commands to operate the electric motors M1 and M2, a shift position (operating position) indication signal for operating a shift indicator, a speed ratio indication signal for indicating a speed ratio, a snow mode indication signal for indicating when the vehicle is being operated in snow mode, an ABS activation signal to activate an ABS actuator that prevents the wheels from slipping during braking, an M mode indication signal that indicates that the M mode has been selected, valve command signals that operate electromagnetic valves (i.e., linear solenoid valves) included in a hydraulic pressure control circuit 70 (see FIGS. 5 and 7) for controlling hydraulic actuators of the hydraulic friction apply devices in the differential portion 11 and the automatic shifting portion 20, a signal for adjusting the line pressure PL using a regulator valve (i.e., a pressure regulating valve) provided in the hydraulic pressure control circuit 70, a drive command signal for operating an electric hydraulic pump which is the source for the base pressure of the line pressure PL to be adjusted, a signal for driving an electric heater, and a signal to be output to a computer for controlling cruise control.

FIG. 5 is a circuit diagram related to linear solenoid valves SL1 to SL5 in the hydraulic pressure control circuit 70 which control the operation of hydraulic actuators (i.e., hydraulic cylinders) AC1, AC2, AB1, AB2, and AB3 of the clutches C and brakes B.

In FIG. 5, linear solenoid valves SL1 to SL5 adjust the line pressure PL to apply pressures PC1, PC2, PB1, PB2, and PB3 according to command signals from the electronic control apparatus 80, and those adjusted apply pressures PC1, PC2, PB1, PB2, and PB3 are supplied directly to the hydraulic actuators AC1, AC2, AB1, AB2, and AB3, respectively. The line pressure PL is adjusted based on a value according to the engine load and the like indicated by the accelerator depression amount A_{CC} or the throttle opening amount θ_{TH}, by a relief type regulating valve (i.e., regulator valve) with the pressure that is generated by a mechanical oil pump, which is driven by the engine 8, or an electric oil pump, not shown, as the base pressure.

The linear solenoid valves SL1 to SL5 all basically have the same structure and are individually energized or de-energized by the electronic control apparatus 80 such that the hydraulic pressures of the hydraulic actuators AC1, AC2, AB1, AB2, AB3 are individually controlled and adjusted to control the apply pressures PC1, PC2, PB1, PB2, and PB3 of the clutches C1 and C2 and the brakes B1, B2, and B3. Then the automatic shifting portion 20 establishes a given speed by applying predetermined apply devices as shown by the clutch and brake application chart in FIG. 2, for example. Also, in shift control of the automatic shifting portion 20, a so-called clutch-to-clutch shift is executed. Incidentally, a clutch-to-clutch shift is a shift in which one clutch C or brake B that is involved in the shift is released at the same time another clutch C or brake B that is also involved in the shift is applied.

FIG. 6 shows one example of a shift operation executing device 50 that serves as switching device that is operated by a person in order to switch among a plurality of various shift positions P_{SH}. This shift operation executing device 50 is provided with a shift lever 52 that is arranged at the side of the driver's seat, for example, and is operated to select any one of the plurality of various shift positions P_{SH}.

This shift lever 52 is provided so as to be manually operated (i.e., shifted) into various positions. These positions include a park position “P”, a reverse “R” position, a neutral position “N”, a drive position “D”, and a manual shift position “M”. Shifting the shift lever 52 into the park position “P” places the transmitting mechanism 10, i.e., the automatic shifting portion 20, in a neutral state in which the power transmitting path therein is interrupted, and locks the output shaft 22 of the automatic shifting portion 20. Shifting the shift lever 52 into the reverse position “R” enables the vehicle to run in reverse. Shifting the shift lever 52 into the neutral position “N” places the transmitting mechanism 10 in a neutral state in which the power transmitting path therein is interrupted. Shifting the shift lever 52 into the drive position “D” establishes a forward automatic shift mode in which automatic shift control is executed within the range of the total shift ratio γT into which the transmitting mechanism 10 can be shifted to obtain i) a continuous speed ratio range of the differential portion 11 and ii) the speeds to which automatic shift control applies within the range of 1st speed to 4th speed in the automatic shifting portion 20. Shifting the shift lever 52 into the manual position “M” establishes a forward manual shift mode (i.e., a manual operation mode) and sets a so-called shift range that limits the high side of the speed (i.e., the highest speed into which the automatic shifting portion 20 can shift) in the automatic shift control of the automatic shifting portion 20.

The hydraulic control circuit 70, for example, can electrically switch in connection with a manual operation of the shift lever 52 into a shift position P_{SH} so as to establish reverse “R”, neutral “N”, or any speed in drive “D”, which are shown in the clutch and brake application chart in FIG. 2.

Of the shift positions P_{SH} “P” through “M”, the “P” and “N” positions are non-running positions that are selected when the vehicle is not to be run. For example, a non-running position is a non-drive position in which the vehicle is unable to be driven because the power transmitting path in the automatic shifting portion 20 is interrupted by the first clutch C1 and the second clutch C2 both being released, as shown in the clutch and brake application chart in FIG. 2. Also, the “R”, “D”, and “M” positions are running positions that are selected when the vehicle is to be run. For example, a running position is a drive position in which the vehicle is able to be driven because the power transmitting path in the automatic shifting portion 20 is established by at least one of the first clutch C1 and the second clutch C2 being applied, as shown in the clutch and application chart in FIG. 2.

More specifically, manually shifting the shift lever 52 from the “P” or “N” position into the “R” position applies the second clutch C2 such that the power transmitting path in the automatic shifting portion 20 changes from being interrupted to being able to transmit power. Manually shifting the shift lever 52 from the “N” position into the “ED” position applies at least the first clutch C1 such that the power transmitting path in the automatic shifting portion 20 changes from being interrupted to being able to transmit power. Also, manually shifting the shift lever 52 from the “R” position into the “P” or “N” position releases the second clutch C2 such that the power transmitting path in the automatic shifting portion 20 changes from being able to transmit power to being interrupted. Manually shifting the shift lever 52 from the “D” position into the “N” position releases both the first clutch C1 and the second clutch C2 such that the power transmitting path in the automatic shifting portion 20 changes from being able to transmit power to being interrupted.

FIG. 7 is a functional block line diagram showing the main portions of the control functions according to the electronic control apparatus 80. In FIG. 7, stepped shift controlling means 82 determines whether to execute a shift in the automatic shifting portion 20 based on the state of the vehicle, which is indicated by the required output torque T_{OUT} of the automatic shifting portion 20 and the actual vehicle speed V from a relationship (shift line graph, shift map) having upshift lines (i.e., the solid lines) and downshift lines (i.e., alternate long and short dash lines) that are stored in advance with the vehicle speed V and the output torque T_{OUT} of the automatic shifting portion 20 as variables, as shown in FIG. 8. That is, the stepped shift controlling means 82 determines the speed into which the automatic shifting portion 20 should shift and executes automatic shift control of the automatic shifting portion 20 to achieve that determined speed.

At this time, the stepped shift controlling means 82 outputs a command (shift output command, hydraulic pressure command) to the hydraulic control circuit 70.

This command is a command to apply and/or release the hydraulic friction apply devices involved in the shift of the automatic shifting portion 20 so as to establish the speed according to the clutch and brake application chart shown in FIG. 2, for example. That is, this command is a command to execute a clutch-to-clutch shift by simultaneously releasing a release-side apply device that is involved in the shift of the automatic shifting portion 20, and applying an apply-side apply device that is involved in the shift of the automatic shifting portion 20. According to that command, the hydraulic pressure control circuit 70 activates the hydraulic actuators of the hydraulic friction apply devices involved in the shift by operating the linear solenoid valves SL in the hydraulic control circuit so that the shift in the automatic shifting portion 20 is executed by releasing the release-side apply device and applying the apply-side apply device.

Hybrid controlling means 84 operates the engine 8 in an efficient operating region while controlling the speed ratio γ0 as the electric continuously variable transmission of the differential portion 11 by changing both the distribution of driving force from the engine 8 and the second electric motor M2 and the reaction force from the power generated by the first electric motor M1 so that they are optimum. For example, the hybrid controlling means 84 calculates a target (i.e., required) output of the vehicle from the vehicle speed V and the accelerator depression amount A_{CC} as the amount of output required by the driver at the speed V at which the vehicle is running at that time. The hybrid controlling means 84 then calculates the necessary total target output from that target output of the vehicle and the charging required value, and calculates the target engine output taking into account transfer loss, loads from auxiliary devices, and the assist torque of the second motor M2 and the like to obtain that total target output. The hybrid controlling means 84 then controls the engine 8 to obtain the engine speed N_{E} and the engine torque T_{E} that can achieve that target engine output, as well as controls the amount of power generated by the first electric motor M1.

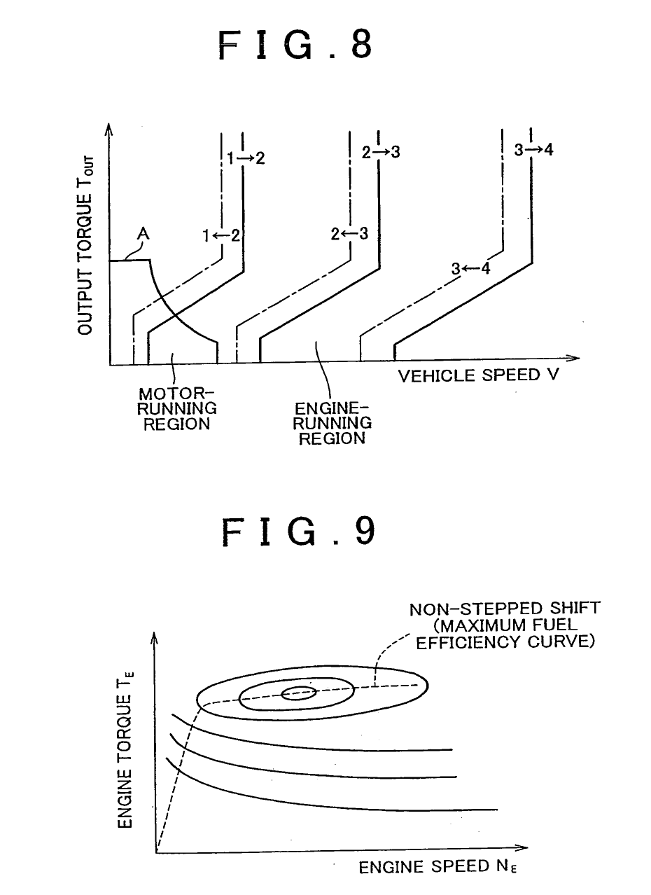

For example, the hybrid controlling means 84 executes that control taking into account the speed of the automatic shifting portion 20 to improve power performance and fuel efficiency and the like. With this kind of hybrid control, the differential portion 11 is made to function as an electric continuously variable transmission in order to match the engine speed N_{E} that is set so that the engine 8 operates in an efficient operating region and the rotation speed of the transmitting member 18 that is set by the vehicle speed and the speed of the automatic shifting portion 20. That is, the hybrid controlling means 84 controls the engine 8 so that it operates along the optimum fuel efficiency curve (fuel efficiency map, relationship) of the engine 8, as shown by the broken line in FIG. 9, which is obtained through testing beforehand and stored, in order to achieve both drivability and fuel efficiency during non-stepped running in a two-dimension coordinate system formed by the engine speed N_{E} and the output torque of the engine 8 (i.e., the engine torque) T_{E}. For example, the hybrid controlling means 84 determines the target value of the total speed ratio γT of the shift mechanism 10 to achieve the engine torque T_{E} and engine speed N_{E} for generating the necessary engine output to satisfy the target output (i.e., the total target output and the required driving force). The hybrid controlling means 84 then controls the speed ratio γ0 of the differential portion 11 taking into account the speed of the automatic shifting portion 20 so as to obtain that target value, and controls the total speed ratio γT so that it is continuous within the range through which shifting is possible.

At this time, the hybrid controlling means 84 supplies electric energy that was generated by the first electric motor M1 to the power storage device 56 and the second electric motor M2 via an inverter 54. Accordingly, power from the engine 8 is mechanically transmitted to the transmitting member 18. However, some of the power from the engine 8 is used (i.e., consumed) to generate power with the first electric motor M1, where it is converted into electric energy. This electric energy is then supplied through the inverter 54 to the second electric motor M2 where it is used to drive the second electric motor M2, and the power generated by the second electric motor M2 is then transmitted to the transmitting member 18. The equipment related to the process that extends from the generation of this electric energy until that electric energy is consumed by the second electric motor M2 converts some of the power from the engine 8 into electric energy and provides an electrical path for that electric energy until that electric energy is converted into mechanical energy.

Also, the hybrid controlling means 84 keeps the engine speed N_{E} substantially constant and controls it to an appropriate speed using the electric CVT function of the differential portion 11, such as by controlling the first electric motor rotation speed N_{M1}, for example, regardless of whether the vehicle is stopped or running. In other words, the hybrid controlling means 84 controls the first electric motor rotation speed N_{M1} to an appropriate rotation speed while keeping the engine speed N_{E} substantially constant and controlling it to an appropriate speed.

For example, as is evident from the alignment graph in FIG. 3, the hybrid controlling means 84 increases the electric motor rotation speed N_{M1} while keeping the second electric motor rotation speed N_{M2} that is restricted by the vehicle speed V (i.e., the speed of the driving wheels 34) substantially constant when increasing the engine speed N_{E} while the vehicle is running. Also, the hybrid controlling means 84 controls the engine speed N_{E} to a predetermined speed by controlling the first electric motor rotation speed N_{M1} when shifting the automatic shifting portion 20. For example, when the hybrid controlling means 84 keeps the engine speed N_{E} substantially constant while shifting the automatic shifting portion 20, it changes the first electric motor rotation speed N_{M1} in the direction opposite the change in the second electric motor rotation speed N_{M2} following a shift in the automatic shifting portion 20 while keeping the engine speed N_{E} substantially constant.

Also, the hybrid controlling means 84 outputs several commands either individually or in combination to the engine output control apparatus 58. These commands are i) a command to control the electronic throttle valve 62 open and closed using the throttle actuator 64 for throttle control, ii) a command to control the fuel injection quantity and timing from the fuel injection apparatus 66 for fuel injection control, and iii) a command to control the ignition timing with the ignition apparatus 68 such as an igniter for ignition timing control. That is, the hybrid controlling means 84 functionally includes engine output controlling means for executing output control of the engine 8 to generate the necessary engine output.

For example, the hybrid controlling means 84 basically executes throttle control to increase the throttle valve opening amount θ_{TH} as the accelerator depression amount A_{CC} increases by driving the throttle actuator 60 based on the accelerator depression amount A_{CC} from a relationship stored beforehand, not shown. Also, the engine output control apparatus 58 executes engine torque control by controlling the fuel injection by the fuel injection apparatus 66 for fuel injection control and controlling the ignition timing by the ignition apparatus 68 such as an igniter for ignition timing control and the like in addition to controlling the electronic throttle valve 62 open and closed using the throttle actuator 64 for throttle control.

Also, the hybrid controlling means 84 can run the vehicle using the motor (i.e., motor-running) by using the electric CVT function (differential operation) of the differential portion 11 regardless of whether the engine 8 is stopped or idling.

For example, the hybrid controlling means 84 determines whether the vehicle is in the motor-running region or the engine-running region based on the vehicle state as indicated by the required output torque Tₒᵤₜ of the automatic shifting portion 20 and the actual vehicle speed from the relationship (driving power source switching line graph, driving power source map) having a boundary line for the engine-running region and the motor-running region in order to switch the driving power source for running between the engine 8 and the second electric motor M2. This relationship uses the vehicle speed V and the output torque T_{OUT} of the automatic shifting portion 20 as variables, as shown in FIG. 8, and is stored in advance. The hybrid controlling means 84 then executes either motor-running or engine-running based on that determination. The driving power source map shown by the solid line A in FIG. 8 is stored in advance along with a shift map showing the solid lines and alternate long and short dash lines in FIG. 8, for example. In this way, the motor-running by the hybrid controlling means 84 is executed in the relatively low output torque T_{OUT} region, i.e., the low engine torque T_{E} region, in which the engine efficiency is typically worse than it is in the high torque region, or the relatively low vehicle speed V region, i.e., low load region, as is evident from FIG. 8.

During motor-running, the hybrid controlling means 84 controls the first electric motor rotation speed N_{M1} with a negative rotation speed in order to suppress the drag from the stopped engine 8 and improve fuel efficiency. For example, the hybrid controlling means 84 allows the first electric motor M1 to rotate idly by eliminating the load on it and keeps the engine speed N_{E} at zero or substantially zero as necessary using the electric CVT function (differential operation) of the differential portion 11.

Also, in the engine-running region as well, so-called torque assist for assisting the power of the engine 8 is made possible by the hybrid controlling means 84 supplying electric energy from the first electric motor M1 from the electrical path described above and/or the electric energy from the power storage apparatus 56 to the second electric motor M2, and driving that second electric motor M2 so as to apply torque to the driving wheels 34.

Also, the hybrid controlling means 84 places the first electric motor M1 in a no-load state thus allowing it to rotate freely (i.e., idly). As a result, the differential portion 11 can be placed in a state equivalent to the state in which the transmission of torque is interrupted, i.e., placed in a state in which the power transmitting path in the differential portion 11 is interrupted, and there is no output from the differential portion 11. That is, the hybrid controlling means 84 can place the differential portion 11 in a neutral state in which the power transmitting path is electrically interrupted by placing the first electric motor M1 in a no-load state.

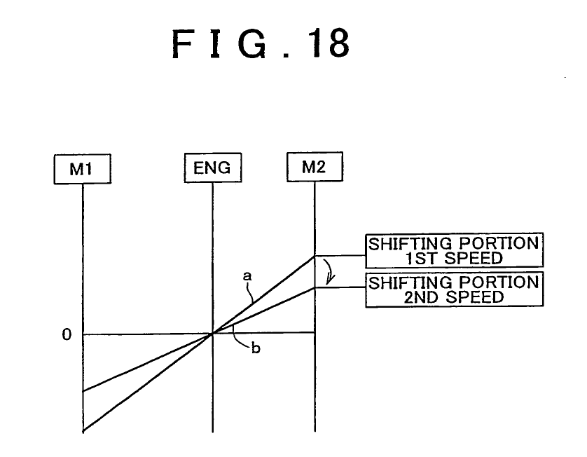

Incidentally, depending on the state of the vehicle, a shift in the automatic shifting portion 20 may be performed even during motor-running as shown in FIG. 18 described above, as is evident from the driving power source map and the shift map shown in FIG. 8. In this case, when the rotation speed N_{IN} of the input shaft 14 changes and the inertia effect from that change is greater than the drag from the engine 8 itself, the first electric motor M1 is made to idle during motor-running. Therefore, there is a possibility that the engine speed N_{E} may change, i.e., may not be able to be kept at zero or substantially zero. This kind of phenomenon may have an adverse effect on drivability due to the inertia effect affecting the output rotating member of the differential portion 11 (i.e., the transmitting mechanism 18). In particular, as shown in FIG. 18, when an upshift is performed in the automatic shifting portion 20 during motor-running, the engine speed N_{E} may enter the negative rotation speed range which may reduce the durability of the engine 8.

Therefore, in this example embodiment, engine speed controlling means 86 for controlling the engine speed when a shift is performed during motor-running is provided. This engine speed controlling means 86 keeps the engine speed N_{E} at a predetermined engine speed N_{E}′ that is higher than zero when a shift is performed in the automatic shifting portion 20 during motor-running. Viewed another way, this engine speed controlling means 86 performs synchronous control in accordance with the progress of the shift in the automatic shifting portion 20 such that the engine speed N_{E} comes to match the predetermined engine speed N_{E}′ by temporarily driving the first electric motor M1.

The predetermined engine speed N_{E}′ is a speed that is higher than zero, which is temporarily set when a shift in the automatic shifting portion 20 is performed during motor-running, and is a target engine speed N_{E}′ that is obtained in advance and stored so that the engine speed N_{E} will not enter the negative rotation speed range even if the engine speed N_{E} changes from the inertia effect following the shift of the automatic shifting portion 20. Incidentally, this predetermined rotation speed N_{E}′ is a predetermined value, but in view of allowing for a change in the engine speed within a predetermined range (such as 20 rpm), a predetermined rotation speed range may be set as a predetermined range instead of that predetermined value.

Accordingly, when a shift is performed in the automatic shifting portion 20 during motor-running, a change in the engine speed N_{E} due to the inertia effect is suppressed. As a result, the effect on the output rotating member of the differential portion 11 is suppressed so drivability improves. In particular, the engine speed N_{E} is inhibited from entering the negative rotation speed range during an upshift in the automatic shifting portion 20 so durability of the engine 8 improves.

More specifically, engine drag determining means 88 determines whether the drag from the engine 8 is exceeding a predetermined value. The drag from the engine 8 decreases as the oil temperature increases and the viscosity of the engine oil decreases as a result. For example, the engine drag determining means 88 determines whether the drag from the engine 8 is exceeding a predetermined value based on whether the temperature of the engine oil, which is detected by an oil temperature sensor, not shown, is equal to or less than a predetermined temperature. The predetermined value is a value of the normal drag from the engine 8 at which the engine speed N_{E} can be kept at zero or substantially zero during motor-running. The predetermined temperature is the temperature of the engine oil at which that normal drag from the engine 8 is exceeded and is obtained in advance through testing. In this way, the engine drag determining means 88 determines whether the drag from the engine 8 is normal.

If the engine drag determining means 88 determines that the drag from the engine 8 is not normal, the hybrid controlling means 84 prohibits motor-running and continues with engine-running or switches to engine-running even if it is determined that the vehicle is in the motor-running range based on the vehicle state from the driving power source map, as shown in FIG. 8, for example.

When the hybrid controlling means 84 determines that the vehicle is in the motor running-range, motor-running determining means 90 determines whether motor-running is being executed.

When the stepped shift controlling means 82 determines the speed into which the automatic shifting portion 20 should be shifted, shift determining means 92 for the shifting portion determines whether a shift has been performed in the automatic shifting portion 20.

Target engine speed setting means 94, which sets the target engine speed when a shift is performed during motor-running, temporarily sets the target engine speed N_{E}′ for the period during the shift in the automatic shifting portion 20 by the stepped shift controlling means 82, e.g., for the period from the time that the determination to perform a shift (hereinafter also referred to as “shift determination”) in the automatic shifting portion 20 is made by the stepped shift controlling means 82 until the shift ends, when i) the engine drag determining means 88 has determined that the drag from the engine 8 is normal, ii) the motor-running determining means 90 has determined that motor-running by the hybrid controlling means 84 is being performed, and iii) the shift determining means 92 has determined that a shift has been performed in the automatic shifting portion 20. The end of the shift is, for example, the point at which the inertia phase ends, and is the point within a predetermined rotation speed difference that is obtained beforehand through testing and set in order to determine that the rotation speed difference between the actual rotation speed N_{IN} of the input shaft 14 and the estimated value of the rotation speed N_{IN} of the input shaft 14 after the shift (=the speed ratio γwhich corresponds to the output shaft rotation speed N_{OUT}×the speed into which the automatic shifting portion 20 is to be shifted) is what it would be after the shift.

The target engine speed N_{E}′ may be set to a constant value. For example, the power consumed to drive the electric motor M1 can be kept down by setting the target engine speed N_{E}′ to as small a value as possible, without the engine speed N_{E} entering the negative rotation speed range, according to the shift in the automatic shifting portion 20 during motor-running.

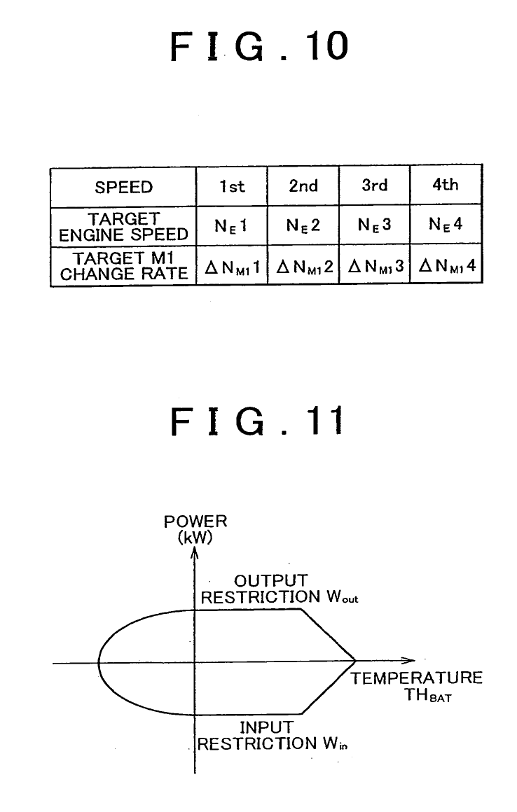

FIG. 10 is a chart showing an example of target engine speeds N_{E}1 to N_{E}4 that are set for each speed before a shift in the automatic shifting portion 20. When the speed ratio steps (=γ(n)/γ(n+1)) are substantially the same, as shown in FIG. 2, the amount of change in the rotation speed (i.e., the change width) of the input shaft 14 during a shift increases, which results in a greater inertia effect, the lower the speed in which the automatic shifting portion 20 is shifted is when viewed at the same vehicle speed. Therefore, the target engine speed N_{E}′ is set increasingly higher for increasingly lower speeds (i.e., speeds with increasingly larger speed ratios) in order to leave enough leeway so that the engine speed does not enter the negative rotation speed range. That is, the target engine speed N_{E}1 that is set for running in 1st speed is set to the highest value. The target engine speeds N_{E}2 and N_{E}3 are set progressively lower for the progressively higher speeds, and the target engine speed N_{E}4 that is set for running in 4th speed is set to the lowest value.

The engine speed controlling means 86 keeps the engine speed N_{E} at the target engine speed N_{E}′ set by the target engine speed setting means 94 while a shift is performed in the automatic shifting portion 20 during motor-running e.g., for a period from a predetermined time before the inertia phase starts during that shift until the inertia phase ends. For example, the engine speed controlling means 86 quickly makes the engine speed N_{E} match the target engine speed N_{E}′ by driving the first electric motor M1 and bringing up the first electric motor rotation speed N_{M1} a predetermined of period of time before the start of the inertia phase, e.g., after a period of time, which is obtained beforehand through testing and set, has passed after a shift command for the automatic shifting portion 20 was output by the stepped shift controlling means 82. The engine speed controlling means 86 then outputs a command to the hybrid controlling means 84 to execute synchronous control that drives the first electric motor M1 and changes the first electric motor rotation speed N_{M1} according to a target first electric motor rotation speed change rate (hereinafter simply referred to as the “target M1 change rate”) ΔN_{M1}′ that matches the change in the rotation speed of the input shaft 14 following a shift in the automatic shifting portion 20 to maintain the target engine speed N_{E}′ from the start of the inertia phase until the end of the inertia phase.

The predetermined period of time before the start of the inertia phase is, for example, the time that it takes to increase the engine speed N_{E} so that it is already up to the target engine speed N_{E}′ when the inertia phase starts. Also, the start of the inertia phase is, for example, the point at which the amount of change in the actual rotation speed N_{IN} of the input shaft 14 exceeds a predetermined amount of change which has been obtained in advance through testing and set to determine that the inertia phase has started.

FIG. 10 also shows an example of target M1 change rates ΔN_{M1}1 to N_{M1}4 set for each speed before a shift in the automatic shifting portion 20. Just as when setting the target engine speed N_{E}′, the amount of change in the rotation speed of the input shaft 14 during a shift increases the lower the speed is so the target M1 change rate ΔN_{M1}′ is set to increase the lower the speed is. That is, the target M1 change rate ΔN_{M1}1 is set to the highest value, the target M1 change rates ΔN_{M1}2 and ΔN_{M1}3 are set progressively lower for the progressively higher speeds, and the target M1 change rate ΔN_{M1}4 is set to the lowest value.

In this way, when a shift is performed in the automatic shifting portion 20 during motor-running, the engine speed controlling means 86 keeps the engine speed N_{E} at the target engine speed N_{E}′ by temporarily driving the first electric motor M1. The first electric motor M1 at this time is driven using power received from the power storage device 56.

Aside from this, when a shift is performed in the automatic shifting portion 20, the first electric motor rotation speed N_{M1} is controlled and a shift is performed in the differential portion 11 taking into account the speed in the automatic transmission 20 so that the hybrid controlling means 84 sets the operating point of the engine 8 on the optimum fuel efficiency curve, e.g., so that the operating point of the engine 8 is kept substantially constant before and after the shift. When the first electric motor rotation speed N_{M1} is controlled at this time, the power generated by the first electric motor M1 is supplied to the power storage device 56 and the second electric motor M2 via the inverter 54.

Here, the power able to be charged or discharged (hereinafter referred to as the “chargeable/dischargeable power”), i.e., the input restriction or output restriction (hereinafter referred to as the “input/output restriction”) W_{IN}/W_{OUT} of the power storage device 56, changes depending on the power storage device temperature TH_{BAT} and the state-of-charge SOC. Therefore, it is necessary to restrict (i.e., limit) charging or discharging (hereinafter referred to as “charging/discharging”) of the power storage device 56 based on the input/output restriction W_{IN}/W_{OUT} so that the durability of the power storage device 56 does not decline. Alternatively or in addition, the possible output (i.e., power) P_{M2} able to be obtained from the second electric motor M2 changes depending on the second electric motor temperature TH_{M2} so the output P_{M2} is restricted. It is therefore necessary to restrict the output from the second electric motor M2 to within that possible output P_{M2} range.

Accordingly, when restrictions are placed on the charging/discharging of the power storage device 56 and the output of the second electric motor M2, the power supplied from the power storage device 56 when driving the first electric motor M1 described above, and/or the power supplied to the power storage device 56 and the second electric motor M2 during power generation with the first electric motor M1 may not be able to be balanced. As a result, the first electric motor rotation speed N_{M1} may not be able to be controlled appropriately when a shift is performed in the automatic shifting portion 20, which may increase shift shock. Aside from this, even when there is a restriction placed on the output of the first electric motor M1, the first electric motor rotation speed N_{M1} may not be able to be controlled appropriately when a shift is performed in the automatic shifting portion 20.

Therefore, in this example embodiment, charging/discharging-restricted shift controlling means 96 makes a determination to perform a shift in the automatic shifting portion 20 so that less power is charged/discharged to/from the power storage device 56, which supplies power when driving the first electric motor M1 or charges with power when the first electric motor M1 generates power, when charging/discharging of the power storage device 56 is restricted compared to when charging/discharging of the power storage device 56 is not restricted.

More specifically, charging/discharging restriction determining means 98 determines whether a restriction is placed on the transfer of power with respect to the power storage device 56, i.e., whether charging/discharging of the power storage device 56 is restricted. For example, the charging/discharging restriction determining means 98 calculates the input restriction W_{IN} and the output restriction W_{OUT} based on the power storage device temperature TH_{BAT} and the state-of-charge SOC, and then determines whether charging/discharging of the power storage device 56 is restricted based on whether at least one of the following conditions is satisfied. The conditions are i) that the calculated input restriction W_{IN} be equal to or less than an input restriction threshold value W_{INth} that has been set beforehand as a charging restriction determining value, and ii) that the output restriction W_{OUT} be equal to or less than an output restriction threshold value W_{OUTth} that was set beforehand as a discharging restriction determining value.

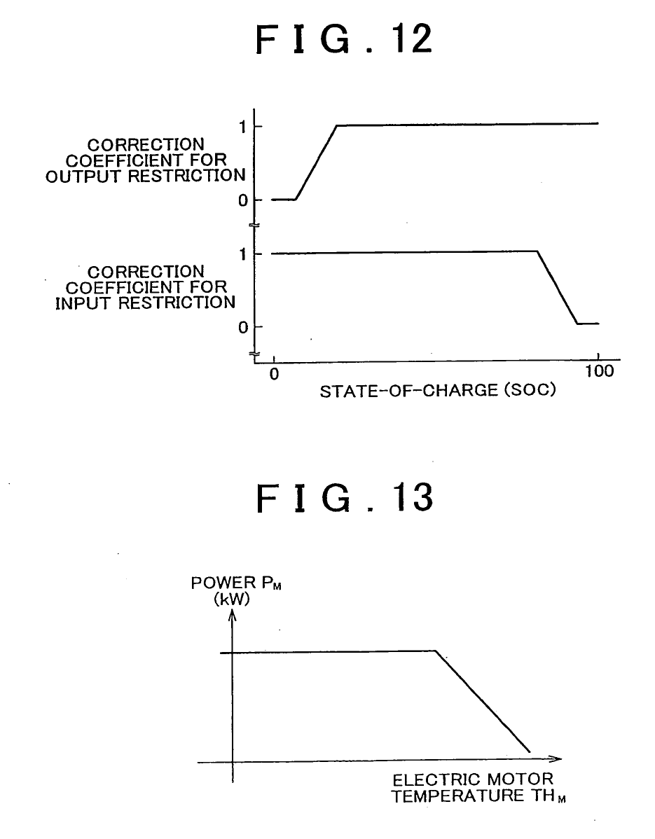

FIG. 11 is a graph (input/output restriction map) showing the relationship that was obtained through testing beforehand between the power storage device temperature TH_{BAT} and the input/output restrictions W_{IN}/W_{OUT}. Also, FIG. 12 is a graph (an input/output restriction correction coefficient map) showing the relationship that was obtained through testing beforehand between the state-of-charge SOC and the correction coefficients for the input/output restrictions W_{IN}/W_{OUT}. The charging/discharging restriction determining means 98 calculates the base value for the input restriction W_{IN} and the base value for the output restriction W_{OUT} based on the power storage device temperature TH_{BAT} from the input/output restriction map shown in FIG. 11, for example. Then the charging/discharging restriction determining means 98 calculates the input restriction correction coefficient and the output restriction correction coefficient based on the state-of-charge SOC from the input/output restriction correction coefficient map shown in FIG. 12. Then the charging/discharging restriction determining means 98 calculates the input restriction W_{IN} by multiplying the input restriction correction coefficient by the base value for the input restriction W_{IN} and calculates the output restriction W_{OUT} by multiplying the output restriction correction coefficient by the base value for the output restriction W_{OUT}.

Electric motor output restriction determining means 100 determines whether the output of the first electric motor M1 and/or the output of the second electric motor M2 is restricted. For example, the electric motor output restriction determining means 100 first calculates possible electric motor outputs P_{M1} and P_{M2} based on the actual electric motor temperatures TH_{M1} and TH_{M2}, respectively, from the relationship (electric motor output graph) obtained through testing in advance between the electric motor temperature TH_{M} and the electric motor output (driving/power generation) P_{M}, as shown in FIG. 13. Then the electric motor output restriction determining means 100 determines whether the output of the electric motors M1 and M2 is restricted based on whether at least one of the following conditions is satisfied. The conditions are i) that the calculated electric motor output P_{M1} be equal to or less than a first electric motor output restriction threshold value P_{M1th} that has been set beforehand as an output restriction determining value, and ii) that the second electric motor output P_{M2} be equal to or less than a second electric motor output restriction threshold value P_{M2th} that was set beforehand as an output restriction determining value.

The charging/discharging-restricted shift controlling means 96 shifts the automatic shifting portion 20 at a lower vehicle speed when the charging/discharging restriction determining means 98 has determined that charging/discharging of the power storage device 56 is restricted, than it does when charging/discharging of the power storage device 56 is not restricted, and/or when the electric motor output restriction determining means 100 has determined that the output of the electric motor M1 and M2 is restricted, than it does when the output of the electric motor M1 and M2 is not restricted. That is, the charging/discharging-restricted shift controlling means 96 shifts the automatic shifting portion 20 at a lower vehicle speed to keep the amount of power used to drive the first electric motor M1 or generate power with the first electric motor M1 down by reducing the change in the rotation speed of the input shaft 14 when the shift is performed in the automatic shifting portion 20.

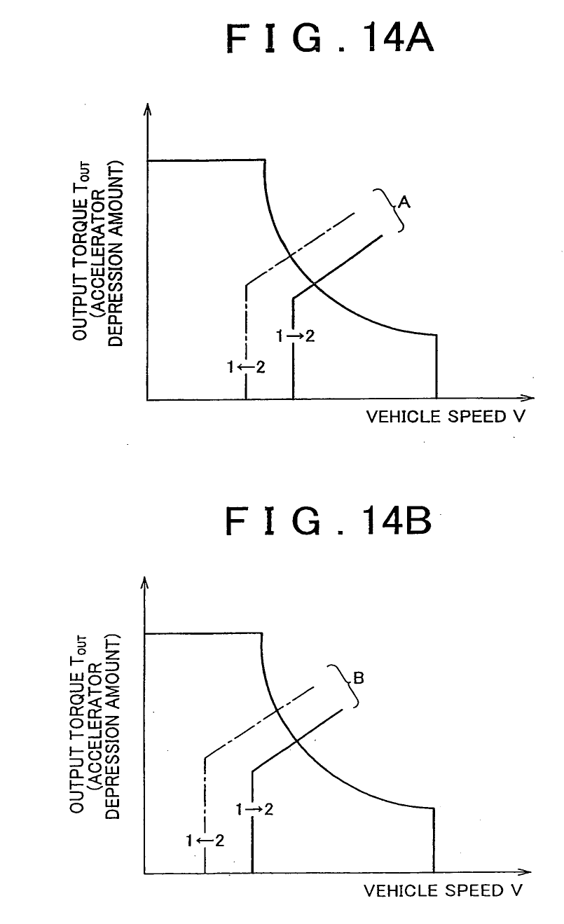

FIG. 14A and FIG. 14B are graphs showing an enlarged view of the motor-running region in the driving power source map and the shift map shown in FIG. 8. FIG. 14A shows an example of 1st [symbol] 2nd shift lines in a first shift map (shift map A), for example, that are normally set when charging/discharging with the power storage device is not restricted and/or when the output of the electric motors M1 and M2 is not restricted. FIG. 14B shows an example of 1st [symbol] 2nd shift lines in a second shift map (shift map B), for example, that are set when discharging of the power storage device 56 is restricted and/or when the output of the electric motors M1 and M2 is restricted. The shift map B shown in FIG. 14B is set such that a shift is performed at a lower vehicle speed than it is with the shift map A that is normally set shown in FIG. 14A. That is, when a shift is performed in the automatic shifting portion 20 when charging/discharging of the power storage device 56 is restricted and/or the output of the electric motors M1 and M2 is restricted, the change in the rotation speed of the input shaft 14 is decreased by executing a shift at a lower vehicle speed compared with when a normal shift is performed. For example, the 1st→2nd upshift line is set so that it only takes a little amount of energy (power) to increase the rotation speed of the first sun gear S1 using the first electric motor M1 during a 1st→2nd upshift.

The charging/discharging-restricted shift controlling means 96 selects the shift map A that is normally set when the charging/discharging restriction determining means 98 has determined that charging/discharging of the power storage device 56 is not restricted and the electric motor output restriction determining means 100 has determined that the output of the electric motors M1 and M2 is not restricted. On the other hand, the charging/discharging-restricted shift controlling means 96 selects the shift map B in which the shift point has been changed to the lower vehicle speed side of the normal shift point so that there is less change in the rotation speed of the input shaft 14, instead of the shift map A that is normally set, when the charging/discharging restriction determining means 98 has determined that charging/discharging of the power storage device 56 is restricted compared to when the charging/discharging of the power storage device 56 is not restricted, and/or when the electric motor output restriction determining means 100 has determined that the output of the electric motors M1 and M2 is restricted compared to when the output of the electric motors M1 and M2 is not restricted. The stepped shift controlling means 82 makes a determination to perform a shift in the automatic shifting portion 20 according to the shift map selected by the charging/discharging-restricted shift controlling means 96, and then executes the shift in the automatic shifting portion 20. In other words, when charging/discharging of the power storage device 56 is restricted and/or when the output of the electric motors M1 and M2 is restricted, the charging/discharging-restricted shift controlling means 96 in essence changes the normal shift point on the shift map toward the lower vehicle speed side.

Accordingly, the power for driving or generating power with the first electric motor M1 is suppressed when a shift is performed in the automatic shifting portion 20. Therefore, even if charging/discharging of the power storage device 56 is restricted, and/or even if the output of the electric motors M1 and M2 is restricted, it is possible to avoid a shift in the automatic shifting portion 20 from being prohibited or motor-running being prohibited because the first electric motor rotation speed N_{M1} can not be appropriately controlled when the shift is performed in the automatic shifting portion 20. Also, the generated power of the first electric motor M1 is suppressed when a shift is performed in the automatic shifting portion 20, which limits the power that can be supplied to the second electric motor M2. This can be viewed as taking into account the power during driving the second electric motor M2 when the charging/discharging-restricted shift controlling means makes the determination to perform a shift in the automatic shifting portion 20 to reduce the power in charging/discharging of the power storage device 56.

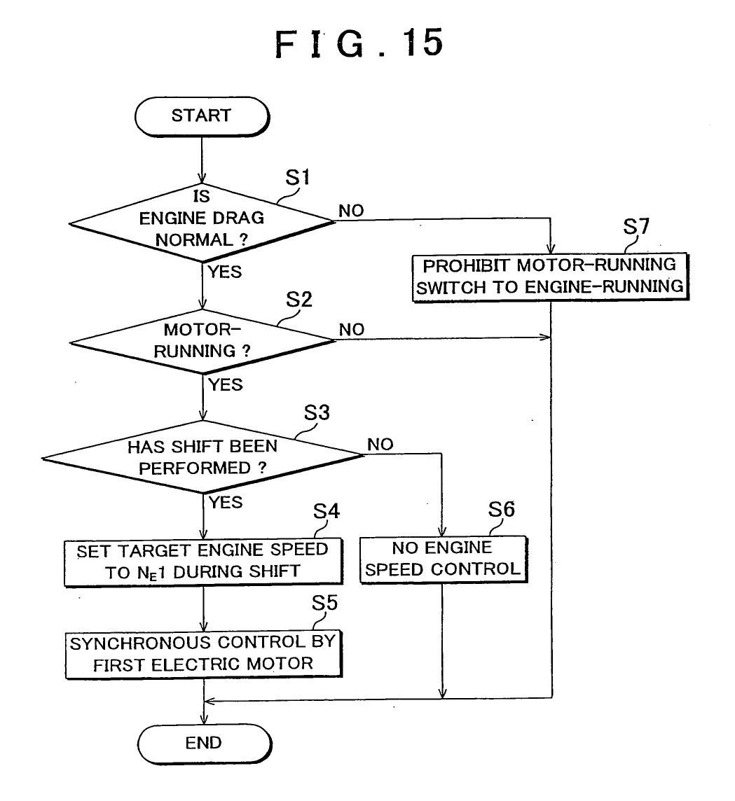

FIG. 15 is flowchart illustrating a routine that includes the main parts of a control operation of the electronic control apparatus 80, i.e., a control operation for improving drivability when performing a shift in the automatic shifting portion 20 during motor-running, particularly a control operation for improving durability of the engine 8 in addition to improving drivability when the shift by the automatic shifting portion 20 is an upshift. This routine is repeatedly executed in extremely short cycles of time such as approximately every several msec to every several tens of msec, for example.

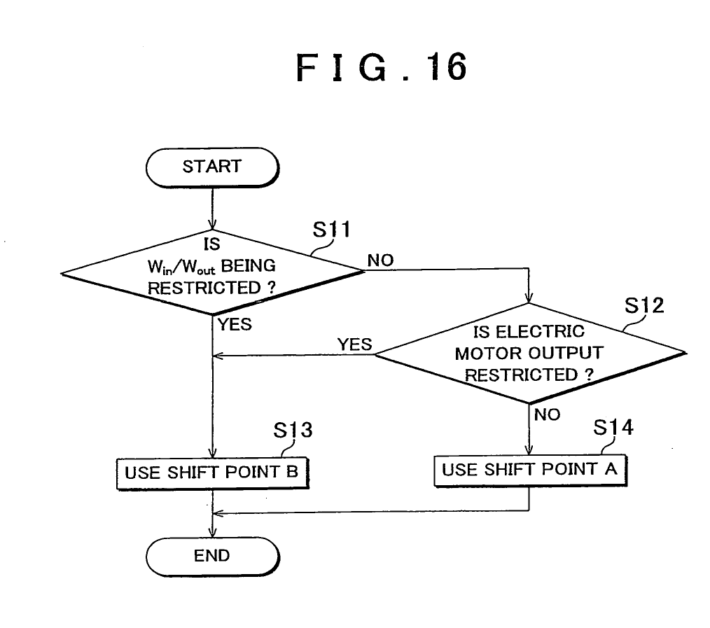

Also, FIG. 16 is a flowchart illustrating a routine that includes the main parts of a control operation of the electronic control apparatus 80, i.e., a control operation for appropriately controlling the first electric motor rotation speed N_{M1} during the shift in the automatic shifting portion 20 in the flowchart in FIG. 15 when charging/discharging of the power storage device 56 is restricted. This routine is repeatedly executed in extremely short cycles of time such as approximately every several msec to every several tens of msec, for example.

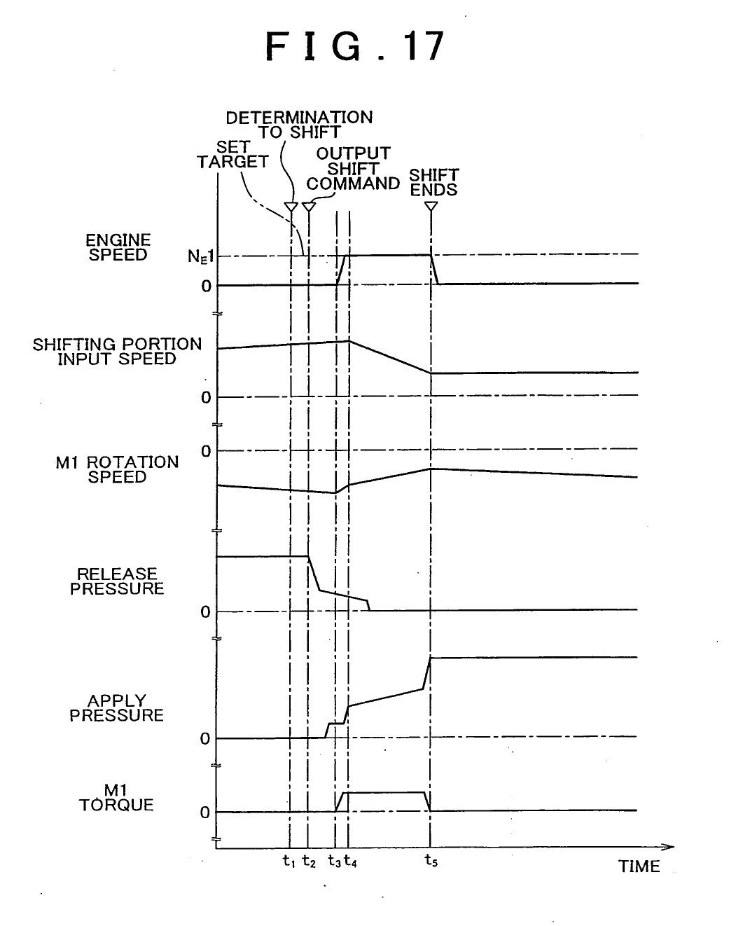

Moreover, FIG. 17 is a time chart showing the control operation in the flowcharts in FIGS. 15 and 16, and an example of a case in which a 1st→2nd upshift is performed in the automatic shifting portion 20 during motor-running.

In FIG. 15, first it is determined in step S1, which corresponds to the engine drag determining means 88, whether the drag from the engine 8 exceeds the predetermined value. For example, the drag from the engine 8 is equal to or less than the predetermined value when, for example, the oil temperature is high and the viscosity of the engine oil is therefore lower, or when the wrong engine oil has been used.

If the determination in step S1 is no, then motor-running is prohibited and engine-running is continued or the mode switching from motor-running to engine-running is executed in step S7, which corresponds to the hybrid controlling means 84, even if the vehicle state was in the motor-running region in the driving power map shown in FIG. 8, for example, because of the possibility that the engine speed N_{E} during motor-running may not be able to be kept at zero or substantially zero.

If the determination in step S1 is yes, on the other hand, it is determined in step S2, which corresponds to the motor-running determining means 90, whether motor-running, which is executed when it is determined that the vehicle state is in the motor-running region from the driving power map shown in FIG. 8, for example, is being performed.

If the determination in step S2 is no, this cycle of the routine ends. If, however, that determination is yes, then it is determined in step S3, which corresponds to the shift determining means 92, whether the speed into which the automatic shifting portion 20 should shift has been determined based on the vehicle state from the shift map shown in FIG. 8, for example, and that shift has been performed in the automatic shifting portion 20.

If the determination in step S3 is yes, the target engine speed N_{E}′ as shown in FIG. 10, for example, is temporarily set in step S4, which corresponds to the target engine speed setting means 94, according to the speed before the shift in the automatic shifting portion 20 while the shift is performed in the automatic shifting portion, e.g., during the period of time from the determination is made to perform a shift in the automatic shifting portion 20 until the shift has ended. For example, the target engine speed N_{E}′ is set to N_{E}1 during an upshift while running in first speed.

Next, in step S5, which corresponds to the engine speed controlling means 86, the engine speed N_{E} is maintained at the target engine speed N_{E}′ that was set in step S4 while a shift is performed in the automatic shifting portion 20 during motor-running, e.g., for the period of time from a predetermined period of time before the start of the inertia phase during that shift until the end of the inertia phase. For example, the engine speed N_{E} is quickly brought up to the target engine speed N_{E}′ by driving the first electric motor M1 and raising the first electric motor rotation speed N_{M1} after a set period of time that was obtained beforehand through testing has passed after a shift command for the automatic shifting portion 20 was output. In addition, a command is output to perform synchronous control that changes the first electric motor rotation speed N_{M1} by driving the first electric motor M1 according to the target M1 change rate ΔN_{M1}′, such as that shown in FIG. 10 for example, that matches the change in the rotation speed of the input shaft 14 following a shift in the automatic shifting portion 20 so as to maintain the target engine speed N_{E}′ from the start of the inertia phase until the end of the inertia phase. In this synchronous control, for example, the actual engine speed N_{E} may be feedback controlled so that it comes into a predetermined range of the target engine speed N_{E}′. Alternatively or in addition, the first electric motor rotation speed N_{M1} may be changed based on the rotation speed or the change in the rotation speed of the input shaft 14, and that first electric motor rotation speed N_{M1} may be feedback controlled so that it comes into a predetermined range of the target engine speed N_{E}′.

In this way, when a shift is performed in the automatic shifting portion 20 during motor-running, the engine speed N_{E} is kept at the target engine speed N_{E}′ by driving the first electric motor M1. At this time, the target engine speed N_{E}′ or the target M1 change rate αN_{M1}′ may be learning controlled based on the results of the control operation of steps S3 to S5 so that the engine speed N_{E} can be more appropriately kept at the target engine speed N_{E}′.

For example, when the actual engine speed N_{E} greatly deviates from the target engine speed N_{E}′, the next target engine speed N_{E}′ for the same speed is corrected so that the engine speed N_{E} will not come near zero. That is, when the actual engine speed N_{E} with respect to the target engine speed N_{E}′ is close to zero, the next target engine speed N_{E}′ for the same speed is set higher.

Also, for example, when the actual engine speed N_{E} greatly deviates from the target engine speed N_{E}′, the next target M1 change rate ΔN_{M1}′ for the same speed is corrected so that the engine speed N_{E} will not come near zero. That is, when the actual engine speed N_{E} with respect to the target engine speed N_{E}′ is close to zero, the set value for the next target M1 change rate ΔN_{M1}′ is set to a larger value so that the actual engine speed N_{E} more quickly reaches the target engine speed N_{E}′.

If, on the other hand, the determination in step S3 is no, then a shift has not been performed in the automatic shifting portion 20 so it is not necessary to set the target engine speed N_{E}′, as is done in step S4, and engine speed control based on that target engine speed N_{E}′, such as that executed in step S5, is not performed in step S6, which corresponds to the target engines speed setting means 94 and the engine speed controlling means 86.

In FIG. 16, first it is determined in step S11, which corresponds to the charging/discharging restriction determining means 98, whether the transfer of power to/from the power storage device 56 is restricted, i.e., whether charging/discharging of the power storage device 56 is restricted.

If the determination in step S11 is no, then it is determined in step S12, which corresponds to the electric motor output restriction determining means 100, based on the heat generated, for example, whether the output from the first electric motor M1 and/or the second electric motor M2 is restricted.

If the determination in step S12 is no, then the shift map A which is normally set is selected in step S14, which corresponds to the charging/discharging-restricted shift controlling means 96. Then in step S3 in FIG. 15, the shift in the automatic shifting portion 20 is determined according to this shift map A and the shift is performed in the automatic shifting portion 20.

If, on the other hand, the determination in step S11 is yes or the determination in step S12 is yes, then the shift map B, in which the shift point has been changed to the lower vehicle speed side of the normal shift point so that there is less change in the rotation speed of the input shaft 14, is selected instead of the normally set shift map A in step S13, which corresponds to the charging/discharging-restricted shift controlling means 96. In step S3 in FIG. 15, the shift in the automatic shifting portion 20 is determined based on this shift map B and the shift is performed in the automatic shifting portion 20. Accordingly, the amount of power delivered to/from the power storage device 56 is decreased. Similarly, the output of the electric motors M1 and M2 is also decreased.

In FIG. 17, time t₁ indicates the point at which a 1st→2nd upshift in the automatic shifting portion 20 is determined during motor-running and at the same time, the target engine speed N_{E} is set to N_{E}1. Then from time t₂, the hydraulic pressure command values for the release pressures and apply pressures for shifting the automatic shifting portion 20 are output and the 1st→2nd upshift in the automatic shifting portion 20 progresses. Time t₄ is the starting point of the inertia phase when the rotation speed N_{IN} of the input shaft 14 starts to change as the 1st→2nd upshift progresses. Time t₅ is the shift end point at which that inertia phase ends.

In the 1st→2nd upshift in the automatic shifting portion 20 during motor-running, the first electric motor M1 is driven and the first electric motor rotation speed N_{M1} is quickly increased from time t₃, which is a predetermined period of time before time t₄, so that at time t₄ the engine speed N_{E} already matches the target rotation speed N_{E}1. Also, from time t₄ until time t₅, the first electric motor rotation speed N_{M1} is increased according to the target M1 change rate ΔN_{M1}1 that matches the change in the rotation speed of the input shaft 14 from the 1st→2nd upshift of the automatic shifting portion 20, and synchronous control by the first electric motor M1 which maintains the target rotation speed N_{E}1 is performed. In this synchronous control, for example, the actual engine speed N_{E} may also be feedback controlled so that it comes into a predetermined range of the target engine speed N_{E}1. Alternatively or in addition, the first electric motor rotation speed N_{M1} may be changed based on the rotation speed or the change in the rotation speed of the input shaft 14, and that first electric motor rotation speed N_{M1} may be feedback controlled so that it comes within a predetermined range of the target engine speed N_{E}1

Also, the target engine speed N_{E}1 or the target M1 change rate ΔN_{M1} 1 may be learning controlled from the successive results of the 1st→2nd upshift of the automatic shifting portion 20. For example, when the actual engine speed N_{E} deviates greatly from the target engine speed N_{E}1, the next target engine speed N_{E}1 is corrected so that the engine speed N_{E} will not come near zero. That is, when the actual engine speed N_{E} with respect to the target engine speed N_{E}′ is close to zero, the next target engine speed N_{E}1 is set higher. Also, when, for example, the actual engine speed N_{E} deviates greatly from the target engine speed N_{E}1, the next target M1 change rate ΔN_{M1}1 is corrected so that the engine speed N_{E} will not come close to zero. That is, when the actual engine speed N_{E} with respect to the target engine speed N_{E}′ is close to zero, the set value for the next target M1 change rate ΔN_{M1}1 is set to a larger value so that the actual engine speed N_{E} more quickly reaches the target engine speed N_{E}′.

Accordingly, in a 1st→2nd upshift in the automatic shifting portion 20 during motor-running, the effect on the output rotating member of the differential portion 11 is suppressed, thereby improving drivability, by suppressing the change in the engine speed N_{E} from the inertia effect. More specifically, the durability of the engine 8 is improved by inhibiting the engine speed N_{E} from entering the negative rotation speed range when the shift in the automatic shifting portion 20 is an upshift.

Also, in the 1st→2nd upshift determination for the automatic shifting portion 20 at time t₁, the shift map (i.e., pattern) A, which is set so that a shift during motor-running will be executed at a vehicle speed V at which the system efficiency, including the efficiency of the second electric motor M2, is greatest, is normally selected. On the other hand, when charging/discharging of the power storage device 56 is restricted or the output of the first electric motor M1 and/or the second electric motor M2 is restricted, the shift map (i.e., pattern) B, which is set to that a shift is executed at a lower vehicle speed compared with shift map (i.e., pattern) A, is selected. Accordingly, the shift is performed in the automatic shifting portion 20 at a lower vehicle speed so less energy (power) is needed for the first electric motor M1 to increase the rotation speed of the first sun gear S1 during synchronous control by the first electric motor M1 during a 1st→2nd upshift. Accordingly, for example, the first electric motor rotation speed N_{M1} can be appropriately controlled even if charging/discharging of the power storage device 56 is restricted.

As described above, according to this example embodiment, the charging/discharging-restricted shift controlling means 96 makes a determination to perform a shift in the automatic shifting portion 20 so that less power is charged/discharged to/from the power storage device 56 when charging/discharging of the power storage device 56 is restricted than when charging/discharging of the power storage device 56 is not restricted. Therefore, the first electric motor rotation speed N_{M1} can be appropriately controlled when a shift is performed in the automatic shifting portion when charging/discharging of the power storage device 56 is restricted. As a result, the durability of the power storage device 56 improves. In addition, shift shock due to not being able to appropriately control the first electric motor rotation speed N_{M1} when a shift is performed in the automatic shifting portion 20 can be suppressed by limiting (i.e., restricting) charging/discharging of the power storage device 56.

Also, according to this example embodiment, the charging/discharging-restricted shift controlling means 96 shifts the automatic shifting portion 20 at a lower vehicle speed when charging/discharging of the power storage device 56 is restricted than when it is not restricted. That is, the shift point in order to determine each shift in the automatic shifting portion 20 on the shift map is changed to the lower vehicle speed side. As a result, the amount of change in the rotation speed of the input shaft 14 is less when a shift is performed in the automatic shifting portion 20, and the power necessary to drive the first electric motor M1 or the power generated by the first electric motor M1 when the engine speed N_{E} is controlled to the target engine speed N_{E}′ is reduced. Therefore, the first electric motor rotation speed N_{M1} can be appropriately controlled even if charging/discharging of the power storage device 56 is restricted.

Also, according to this example embodiment, the charging/discharging-restricted shift controlling means 96 makes a determination to perform a shift in the automatic shifting portion 20 so that less power is charged to or discharged from the power storage device 56 when charging/discharging of the power storage device 56 is restricted during motor-running in which only the second electric motor M2 is used as the driving power source than when charging/discharging of the power storage device 56 is not restricted. Accordingly, the first electric motor rotation speed N_{M1} can be appropriately controlled when a shift is performed in the automatic shifting portion 20 during motor-running. In particular, the engine speed N_{E} can be inhibited from entering the negative rotation speed range in an upshift in the automatic shifting portion 20, thereby improving the durability of the engine 8.

Also, according to this example embodiment, the charging/discharging-restricted shift controlling means 96 makes a determination to perform a shift in the automatic shifting portion 20 so that less power is charged to or discharged from the power storage device 56, taking into account the power when driving the second electric motor M2. As a result, the first electric motor rotation speed N_{M1} can be controlled even more appropriately when a shift is performed in the automatic shifting portion 20 during motor running. For example, even if neither charging nor discharging is preferable considering the durability of the power storage device 56, a shift can be performed in the automatic shifting portion 20 so that the balance of power becomes equal to or near zero and the first electric motor rotation speed N_{M1} can be controlled even more appropriately.

Also, according to this example embodiment, charging/discharging of the power storage device 56 is restricted based on the power storage device temperature TH_{BAT} and the state-of-charge SOC. Therefore, charging/discharging of the power storage device 56 can be appropriately restricted, which enables a decline in durability of the power storage device 56 to be suppressed.

While the invention has been described in detail with reference to an example embodiment thereof, it is to be understood that the invention is not restricted to this example embodiment, but may also be applied to other example embodiments.

For example, the foregoing example embodiment illustrates two types of shift patterns, i.e., shift pattern A which is used when charging/discharging of the power storage device 56 is not restricted and shift pattern B which is used when charging/discharging of the power storage device 56 is restricted. However, the shift pattern is not restricted to these patterns, i.e., other various patterns may also be used. For example, a shift may be performed in the automatic shifting portion 20 at a lower vehicle speed the more restricted charging/discharging of the power storage device 56 is, or the more restricted the output of the first electric motor M1 and/or M2 is. That is, the shift point on the shift map may be shifted (changed) continuously, for example, toward the lower vehicle speed side. This enables the first electric motor rotation speed N_{M1} to be controlled even more appropriately according to the charging/discharging restriction of the power storage device 56 (or according to the output restriction of the first electric motor M1 and/or the second electric motor M2).

Also, in the foregoing example embodiment, the flowchart in FIG. 16 is described as a control operation for selecting a shift map that can be used in a determination to perform a shift in the automatic shifting portion 20 during motor-running in the flowchart in FIG. 15. Alternatively, however, the control operation in FIG. 16 may also be applied to a determination to perform a shift in the automatic shifting portion 20 other than during motor-running. For example, the control operation in FIG. 16 can also be applied to a determination to perform a shift in the automatic shifting portion 20 when controlling the engine speed. N_{E} to a predetermined speed by controlling the first electric motor rotation speed N_{M1} during a shift in the automatic shifting portion 20, i.e., when keeping the operating point of the engine 8 substantially constant before and after a shift in the automatic shifting portion 20 during engine-running.

Also, in the foregoing example embodiment, the shift map in which the shift point is shifted to the lower vehicle speed side is uniformly selected when charging/discharging of the power storage device 56 is restricted. Alternatively, however, the shift map may be selected for when only charging to the power storage device 56 is restricted or when only discharging from the power storage device 56 is restricted. For example, when only charging to the power storage device 56 is restricted, the charging/discharging-restricted shift controlling means 96 may make a determination to perform a shift in the automatic shifting portion 20 when the power storage device 56 is discharging or so that power charged to the power storage device 56 possibly decreases. Alternatively or in addition, when only discharging from the power storage device 56 is restricted, the charging/discharging-restricted shift controlling means 96 may make a determination to perform a shift in the automatic shifting portion 20 when the power storage device 56 is charging or so that power discharged from the power storage device 56 possibly decreases. More specifically, when only charging to the power storage device 56 is restricted, the shift map that specifies a shift at a lower vehicle speed is selected with a determination to perform a shift in the automatic shifting portion 20 during engine-running in which the first electric motor M1 is in a power generating state. On the other hand, the normal shift map is selected with a determination to perform a shift in the automatic shifting portion 20 during motor-running in which the first electric motor M1 is in a driving state. Conversely, when only discharging from the power storage device 56 is restricted, the shift map that specifies a shift at a lower vehicle speed is selected with a determination to perform a shift in the automatic shifting portion 20 during motor-running in which the first electric motor M1 is in a driving state. On the other hand, the normal shift map is selected with a determination to perform a shift in the automatic shifting portion 20 during engine-running in which the first electric motor M1 is in a power generating state. Accordingly, the first electric motor rotation speed N_{E} can be controlled even more appropriately according to the restriction on charging/discharging of the power storage device 56. For example, the opportunity for a determination to perform a shift in the automatic shifting portion 20 that is normally performed when charging/discharging of the power storage device 56 is not restricted increases compared to when a determination to perform a shift in the automatic shifting portion 20 is made uniformly so that less power is charged/discharged to/from the power storage device 56 when only charging (or discharging) of the power storage device 56 is restricted. As a result, the opportunity increases for a shift determination to be made using the normal shift patter that is set to obtain the greatest system efficiency including the efficiency of the second electric motor M2.

Also, in the foregoing example embodiment, the target engine speed N_{E}′ or the target M1 change rate ΔN_{M1}′ is learning controlled based on the shift result so that the engine speed N_{E} can be more appropriately maintained at the target engine speed N_{E}′. Even with this kind of learning, when the ability to keep the engine speed N_{E} at the target engine speed N_{E}′ is unable to be radically improved at the normal oil temperature, for example, the engine drag determining means 88 (i.e., step S1 in FIG. 15) may regard the drag from the engine 8 as being equal to or less than the predetermined value. As a result, the hybrid controlling means 84 (i.e., step S7 in FIG. 15) may prohibit motor-running.

Also, in the foregoing example embodiment, the target engine speed setting means 94 temporarily sets the target engine speed N_{E}′ during the period from the time the determination to perform a shift in the automatic shifting portion 20 is made by the first shift determining means 82 until the shift ends. Alternatively, however, the target engine speed N_{E}′ does not have to be set from the shift determination of the automatic shifting portion 20 as long as it is at least set a predetermined period of time before the inertia phase starts at which time the engine speed controlling means 86 starts to increase the engine speed N_{E} to the target engine speed N_{E}′ by driving the first electric motor M1.

Also in the foregoing example embodiment, the motor-running region may be increased using the shift point on the side that increases the amount of charging to the power storage device 56 in order to increase the backup-running region when out of gas for example.

Also in the foregoing example embodiment, the differential portion 11 (i.e., the power split mechanism 16) functions as an electric continuously variable transmission in which the speed ratio γcontinuously changes from a minimum value γ0min to a maximum value γ0max. However, the invention may also be applied to a case in which the differential portion 11 (i.e., the power split mechanism 16) changes the speed ratio γ0 of the differential portion 11 in a stepped manner, instead of continuously, using differential operation.

Also in the foregoing example embodiment, the differential portion 11 may also include a differential limiting device that is provided in the power split device 16 and is operated also as a stepped transmission with at least two forward speeds by limiting the differential operation. The invention may also be applied when a vehicle is running when the differential operation of the differential portion 11 (i.e., the power split device 16) is not restricted by solely by this differential limiting device.

Also, in the power split device 16 of the foregoing example embodiment, the first carrier CA1 is connected to the engine 8, the first sun gear S1 is connected to the first electric motor M1, and the first ring gear R1 is connected to the transmitting member 18. However, the connective relationships are not necessary restricted to these. That is, the engine 8, the first electric motor M1, and the transmitting member 18 may be connected to any one of the three elements CA1, S1, and R1 of the first planetary gear set 24.

Also in the foregoing example embodiment, the engine 8 is directly connected to the input shaft 14. However, the engine 8 may be operatively connected via a gear or a belt or the like and does need not to be arranged on the same axis as the input shaft 14.

Also in the foregoing example embodiment, the first electric motor M1 and the second electric motor M2 are arranged concentric with the input shaft 14, with the first electric motor M1 being connected to the first sun gear S1 and the second electric motor M2 being connected to the transmitting member 18. However, the invention is not necessarily restricted to this arrangement. For example, the first electric motor M1 may be operatively connected to the sun gear S1 via a gear, belt, or reduction gear, and the second electric motor M2 operatively connected to the transmitting member 18 via a gear, belt, or reduction gear.

Also in the foregoing example embodiment, the hydraulic friction apply devices such as the first clutch C1 and the second clutch C2 may be magnetic-particle type apply devices such as powder clutches, electromagnetic type apply devices such as electromagnetic clutches, or mechanical type apply devices such as a mesh type dog clutch or the like. When an electromagnetic clutch is used, for example, the hydraulic pressure control circuit 70 is formed of a switching device or an electromagnetic switching device or the like that switches an electric command signal circuit to the electromagnetic clutch, instead of a valve device that switches the hydraulic circuit.

Also in the foregoing example embodiment, the automatic shifting portion 20 is arranged in the power transmitting path between the transmitting member 18 which is the output member of the differential portion 11, i.e., the power split device 16, and the driving wheels 34. Alternatively, however, another kind of shifting portion (i.e., transmission) may also be provided, such as a continuously variable transmission (CVT), which is one type of automatic transmission, or a constant mesh parallel twin shaft type automatic transmission (constant mesh parallel twin shaft type manual transmissions are well known) which is capable of automatically switching speeds using a select cylinder and a shift cylinder. The invention may also be applied with these as well.

Also in the foregoing example embodiment, the automatic shifting portion 20 is directly connected to the differential portion 11 via the transmitting member 18. Alternatively, however, a countershaft may be provided parallel to the input shaft 14 and the automatic shifting portion 20 may be arranged on the same axis as the countershaft. In this case, the differential portion 11 and the automatic shifting portion 20 are connected so that power can be transmitted, for example, via a counter gear set which serves as the transmitting member 18, or a set of transmitting members made up of a sprocket and chain or the like.

Also, the power split device 16 that serves as the differential mechanism in the foregoing example embodiment may be differential gear set in which a pinion that is rotatably driven by the engine and a pair of umbrella gears that mesh with the pinion are operatively connected to the first electric motor M1 and the transmitting member 18 (the second electric motor M2).

Also, the power split device 16 in the foregoing example embodiment is formed of a planetary gear set. However, the power split device 16 may also be formed of two or more planetary gear sets and function as a transmission with three or more speeds in a non-differential state (i.e., in a constant shift state). Also, the planetary gear set is not restricted to being a single pinion type planetary gear set, but may also be a double pinion type planetary gear set.

Also, the shift operation executing device 50 in the foregoing example embodiment is provided with the shift lever 52 that is operated to select any one of a plurality of various shift positions P_{SH}. Alternatively, however, instead of the shift lever 52, for example, a switch such as a pushbutton switch or a sliding switch that can select any one of the plurality of various shift positions P_{SH} may be provided, or a device that switches between a plurality of various shift positions P_{SH} in response to the voice of the driver without relying on a manual operation may be provided, or a device that switches between a plurality of various shift positions P_{SH} according to a foot operation may be provided. Also, in the foregoing example embodiment, the shift range is set by shifting the shift lever 52 into the “M” position. Alternatively, however, the speed may be set, i.e., the highest speed in each shift range may be set as the speed. In this case, the speed may be switched and a shift executed in the automatic shifting portion 20. For example, when the shift lever 52 is manually operated into the upshift position “+” or the downshift position “−” of the “M” position, any speed from 1st speed to 4th speed may be set in the automatic shifting portion 20 according to an operation of the shift lever.

While some embodiments of the invention have been illustrated above, it is to be understood that the invention is not restricted to details of the illustrated embodiments, but may be embodied with various changes, modifications or improvements, which may occur to those skilled in the art, without departing from the spirit and scope of the invention.

What is claimed is:

1. A control apparatus of a vehicular drive system, comprising:
an electric differential portion that has a differential mechanism which has a first element that is connected to an engine, a second element that is connected to a first electric motor, and a third element that is connected to a transmitting member, the differential mechanism distributing output from the engine to the first electric motor and the transmitting member;
a shifting portion that is provided in a power transmitting path between the transmitting member and a driving wheel;
a power storage device that supplies power which is used to drive the first electric motor or charges power which is generated by the first electric motor; and
a charging/discharging-restricted shift control apparatus that makes a determination to perform a shift in the shifting portion such that less power is charged to the power storage device or discharged from the power storage device when charging or discharging of the power storage device is restricted than when charging or discharging of the power storage device is not restricted, when a shift is performed in the shifting portion by controlling the rotation speed of the first electric motor.

2. The control apparatus according to claim 1, wherein the charging/discharging-restricted shift control apparatus makes the shifting portion shift at a lower vehicle speed when charging or discharging of the power storage device is restricted than when charging or discharging of the power storage device is not restricted.

3. The control apparatus according to claim 2, wherein the charging/discharging-restricted shift control apparatus makes the shifting portion shift at a progressively lower vehicle speed the more charging or discharging of the power storage device is restricted.

4. The control apparatus according to claim 1, wherein the shifting portion is an automatic transmission in which a shift is executed according to a preset first shift map, and the charging/discharging-restricted shift control apparatus executes a shift according to a second shift map which is set to shift at a lower vehicle speed than the vehicle speed set by the first shift map.

5. The control apparatus according to claim 4, wherein the charging/discharging-restricted shift control apparatus changes a shift point farther to the lower vehicle speed side the more charging or discharging of the power storage device is restricted.

6. The control apparatus according to claim 1, wherein when only charging to the power storage device is restricted, the charging/discharging-restricted shift control apparatus makes a determination to perform a shift in the shifting portion such that the power that is charged to the power storage device become lower, or makes the determination when the power storage device discharges.

7. The control apparatus according to claim 1, wherein when only discharging from the power storage device is restricted, the charging/discharging-restricted shift control apparatus makes a determination to perform a shift in the shifting portion such that the power that is discharged from the power storage device become lower, or makes the determination when the power storage device charges.

8. The control apparatus according to claim 1, further including: a second electric motor that is connected to the transmitting member, wherein the charging/discharging-restricted shift control apparatus makes a determination to perform a shift in the shifting portion such that less power is charged to the power storage device or discharged from the power storage device when charging or discharging of the power storage device is restricted than when charging or discharging of the power storage device is not restricted, during motor-running in which only the second motor is used as a driving power source.

9. The control apparatus according to claim 8, wherein the charging/discharging-restricted shift control apparatus makes the determination to perform a shift in the shifting portion such that less power is charged to the power storage device or discharged from the power storage device taking into account the power which is used to drive the second electric motor.

10. The control apparatus according to claim 1, wherein charging or discharging of the power storage device is restricted based on a temperature of the power storage device.

11. The control apparatus according to claim 1, wherein charging or discharging of the power storage device is restricted based on a state-of-charge of the power storage device.

12. The control apparatus according to claim 1, wherein the electric differential portion operates as a continuously variable transmission by the operating state of the first electric motor being controlled.

13. The control apparatus according to claim 1, wherein the differential mechanism is a planetary gear set, the first element is a carrier of the planetary gear set, the second element is a sun gear of the planetary gear set, and the third element is a ring gear of the planetary gear set.

14. The control apparatus according to claim 13, wherein the planetary gear set is a single pinion type planetary gear set.

15. The control apparatus according to claim 1, wherein a total speed ratio of the vehicular drive system is obtained based on a speed ratio of the shifting portion and a speed ratio of the electric differential portion.

16. The control apparatus in claim 1, wherein the shifting portion is a stepped automatic transmission.

17. The control apparatus according to claim 1, wherein the charging/discharging-restricted shift control apparatus makes a determination to perform a shift in the shifting portion such that only the power charged to the power storage device decreases when only charging to the power storage device is restricted.

18. The control apparatus according to claim 1, wherein the charging/discharging-restricted shift control apparatus makes a determination to perform a shift in the shifting portion such that only the power discharged from the power storage device decreases when only discharging from the power storage device is restricted.

19. A control method for a vehicular drive system that includes i) an electric differential portion that has a differential mechanism which has a first element that is connected to an engine, a second element that is connected to a first electric motor, and a third element that is connected to a transmitting member, the differential mechanism distributing output from the engine to the first electric motor and the transmitting member, ii) a shifting portion that is provided in a power transmitting path between the transmitting member and a driving wheel, and iii) a power storage device that supplies power which is used to drive the first electric motor or charges power which is generated by the first electric motor, the control method comprising:
making a determination to perform a shift in the shifting portion such that less power is charged to the power storage device or discharged from the power storage device when charging or discharging of the power storage device is restricted than when charging or discharging of the power storage device is not restricted, when a shift is performed in the shifting portion by controlling the rotation speed of the first electric motor.
